(19) United States
(12) Patent Application Publication
(10) Pub. No.: US 2025/0355258 A1
(43) Pub. Date: Nov. 20, 2025

(54) OPTICAL SYSTEM, IMAGE PROJECTION DEVICE, AND DISPLAY POSITION DETECTION DEVICE

(71) Applicant: Panasonic Intellectual Property Management Co., Ltd., Osaka (JP)

(72) Inventors: Satoshi KUZUHARA, Osaka (JP); Tsuneo Uchida, Chiba (JP); Junichi Asada, Hyogo (JP)

(21) Appl. No.: 19/286,539

(22) Filed: Jul. 31, 2025

Related U.S. Application Data
(63) Continuation of application No. PCT/JP2023/046406, filed on Dec. 25, 2023.

(30) Foreign Application Priority Data
Feb. 3, 2023 (JP) 2023-015574

(51) Int. Cl. G02B 27/01; G02B 27/09; G02B 27/10

(52) U.S. Cl. CPC G02B 27/0172; G02B 27/0972; G02B 27/1026

(57) ABSTRACT

An optical system includes: a first optical system for allowing a first light beam group to form a first formation image on an imaging plane; and a second optical system for allowing a second light beam group to form a second formation image on the imaging plane. The first optical system includes a first reflective surface group which reflects the first light beam group to allow the first light beam group to be incident on the imaging plane and includes a first reflective surface with a concave shape. The second optical system includes a second reflective surface group which reflects the second light beam group to allow the second light beam group to be incident on the imaging plane and includes a second reflective surface with a concave shape. The first formation image and the second formation image overlap each other within the imaging plane.

### CROSS-REFERENCE TO RELATED APPLICATIONS

The present application is a continuation of PCT/JP2023/046406 filed Dec. 25, 2023, which claims priority to Japanese Patent Application No. 2023-015574, filed on Feb. 3, 2023, the entire contents of which are incorporated herein by reference.

### TECHNICAL FIELD

The present disclosure relates to optical systems, image projection devices, and display position detection devices.

### BACKGROUND ART

Patent literature 1 discloses an HMD (head-mounted display) device. The HMD device disclosed in patent literature 1 includes a camera, a combiner optic and a processor for the purpose of detecting and correcting binocular misalignment. The combiner optic has a 45-degree angled internal surface at its left end, which reflects a partial left image 90 degrees to the right. The combiner optic includes an internal optical combining interface at its right end. This is a 50-50 beam splitter with a reflective coating on one surface. The internal optical combining interface allows a partial right image to propagate to the camera and reflects the partial left image 90 degrees to be incident on the camera.

### CITATION LIST

### Patent Literature

PATENT LITERATURE: U.S. Pat. No. 10,425,636 B2

### SUMMARY OF INVENTION

### Technical Problem

The HMD device disclosed in patent literature 1 uses the combiner optic to allow partial left and right images to be incident on the camera. However, the combiner optic employs the 50 to 50 beam splitters (half mirrors) and therefore total light amount of light beam groups of the partial left and right images incident on the camera light is equal to or smaller than a half of that incident on the combiner optic.

The present disclosure provides optical systems, image projection devices and display position detection devices which enable reducing loss of light beam groups to be incident on an imaging plane.

### Solution to Problem

An optical system according to an aspect of present disclosure is an optical system for allowing, in relation to an image projection device projecting images on eyes of an observer, a first light beam group forming a first image to be projected on a first eye of the observer and a second light beam group forming a second image to be projected on a second eye of the observer, to form images on an imaging plane, including: a first optical system for allowing the first light beam group to form a first formation image on the imaging plane; and a second optical system for allowing the second light beam group to form a second formation image on the imaging plane. The first optical system includes a first reflective surface group which reflects the first light beam group to allow the first light beam group to be incident on the imaging plane and includes at least a first reflective surface with a concave shape. The second optical system includes a second reflective surface group which reflects the second light beam group to allow the second light beam group to be incident on the imaging plane and includes at least a second reflective surface with a concave shape. The first formation image and the second formation image overlap each other within the imaging plane.

An image projection device according to an aspect of the present disclosure includes an optical system. The optical system is an optical system for allowing, in relation to an image projection device projecting images on eyes of an observer, a first light beam group forming a first image to be projected on a first eye of the observer and a second light beam group forming a second image to be projected on a second eye of the observer, to form images on an imaging plane, including: a first optical system for allowing the first light beam group to form a first formation image on the imaging plane; and a second optical system for allowing the second light beam group to form a second formation image on the imaging plane. The first optical system includes a first reflective surface group which reflects the first light beam group to allow the first light beam group to be incident on the imaging plane and includes at least a first reflective surface with a concave shape. The second optical system includes a second reflective surface group which reflects the second light beam group to allow the second light beam group to be incident on the imaging plane and includes at least a second reflective surface with a concave shape. The first formation image and the second formation image overlap each other within the imaging plane. The first optical system and the second optical system are constituted by a prism. The first optical system further includes a first incident surface allowing the first light beam group to enter the prism and a first exit surface allowing the first light beam group to emerge from the prism to the imaging plane. The first reflective surface group reflects the first light beam group inside the prism. The second optical system further includes a second incident surface allowing the second light beam group to enter the prism and a second exit surface allowing the second light beam group to emerge from the prism to the imaging plane. The second reflective surface group reflects the second light beam group inside the prism. The optical system includes a first light guide allowing propagation of the first light beam group toward the first eye of the observer; and a second light guide allowing propagation of the second light beam group toward the second eye of the observer. The prism constituting the first optical system and the second optical system is formed integrally with the first light guide and the second light guide to allow part of the first light beam group propagating inside the first light guide to be incident on the first incident surface as well as to allow part of the second light beam group propagating inside the second light guide to be incident on the second incident surface. The image projection device includes a first image unit configured to output the first light beam group toward the first light guide; and a second image unit configured to output the second light beam group toward the second light guide.

A display position detection device according to an aspect of the present disclosure includes an optical system. The optical system is an optical system for allowing, in relation to an image projection device projecting images on eyes of an observer, a first light beam group forming a first image to be projected on a first eye of the observer and a second light beam group forming a second image to be projected on a second eye of the observer, to form images on an imaging plane, including: a first optical system for allowing the first light beam group to form a first formation image on the imaging plane; and a second optical system for allowing the second light beam group to form a second formation image on the imaging plane. The first optical system includes a first reflective surface group which reflects the first light beam group to allow the first light beam group to be incident on the imaging plane and includes at least a first reflective surface with a concave shape. The second optical system includes a second reflective surface group which reflects the second light beam group to allow the second light beam group to be incident on the imaging plane and includes at least a second reflective surface with a concave shape. The first formation image and the second formation image overlap each other within the imaging plane. A size of an overlap between the first formation image and the second formation image within the imaging plane is equal to or larger than 20% of a size of the first formation image or the second formation image. The display position detection device includes a detector configured to detect a positional relation between the first formation image and the second formation image, from a positional relation between an image point of the first optical system and an image point of the second optical system based on the first formation image and the second formation image obtained from the imaging plane.

### Advantageous Effects of Invention

Aspects of the present disclosure enables reduction of loss of light beam groups to be incident on an imaging plane.

### BRIEF DESCRIPTION OF DRAWINGS

FIG. 1 is a schematic view of a configuration example of an image projection device according to embodiment 1.

FIG. 2 is a schematic view of an optical system of the image projection device according to embodiment 1.

FIG. 3 is an explanatory view of an optical path of the optical system according to embodiment 1, viewed in a +Y direction.

FIG. 4 is an explanatory view of optical paths of a first optical system and a second optical system of the optical system according to embodiment 1.

FIG. 5 is an explanatory view of an optical path of the optical system according to embodiment 1, viewed in a −X direction.

FIG. 6 is a flowchart of a detection process of the image projection device according to embodiment 1.

FIG. 7 is an explanatory diagram of an example of a calibration process of the image projection device according to embodiment 1.

FIG. 8 is an explanatory view of examples of a first formation image and a second formation image according to the image projection device of FIG. 7.

FIG. 9 is an explanatory diagram of an example of a calibration process of the image projection device according to embodiment 1.

FIG. 10 is an explanatory view of examples of a first formation image and a second formation image according to the image projection device of FIG. 9.

FIG. 11 is a schematic view of a configuration example of an optical system of an image projection device according to embodiment 2.

FIG. 12 is a schematic view of a configuration example of an optical system of an image projection device according to embodiment 3.

FIG. 13 is a schematic view of a configuration example of an optical system of an image projection device according to embodiment 4.

FIG. 14 is a schematic view of a configuration example of an optical system of an image projection device according to embodiment 5.

FIG. 15 is a schematic view of a configuration example of an image projection device according to embodiment 6.

FIG. 16 is a schematic view of a configuration example of an image projection device according to embodiment 7.

FIG. 17 is a schematic view of a configuration example of an image projection device according to embodiment 8.

FIG. 18 is an explanatory view of examples of a first formation image and a second formation image according to one variation.

FIG. 19 is an explanatory view of examples of a first formation image and a second formation image according to another variation.

### DESCRIPTION OF EMBODIMENTS

### 1. Embodiments

Hereinafter, embodiments of the present disclosure will be described with reference to the drawings where appropriate. However, the following embodiments are merely examples for explaining the present disclosure, and are not intended to limit the present disclosure to the following content (e.g., shapes, dimensions, arrangement and the like, of components). Positional relations such as up, down, left, and right are based on the positional relations shown in the drawings, unless otherwise specified. Each figure described in the following embodiments is a schematic diagram, and the ratios of size and thickness of each component in each figure do not necessarily reflect the actual dimensional ratios. Furthermore, the dimensional ratios of each element are not limited to the ratios shown in the drawings.

In the following description, if it is necessary to distinguish a plurality of components from each other, prefixes, such as, “first”, “second”, or the like are attached to names of such components. However, if these components can be distinguished from each other by reference signs attached to those components, such prefixes, such as, “first”, “second”, or the like, may be omitted in consideration of readability of texts.

In the present disclosure, expressions “travel in_direction” and “propagate in direction” used in relation to light rays mean that a light ray forming an image travels in the_direction as a whole and therefore light beams included in the light ray forming the image may be permitted to be inclined relative to the_direction. For example, regarding a “light ray traveling in_direction”, it is sufficient that a main light beam of this light is directed in the_direction, and auxiliary beams of this light may be inclined relative to the_direction.

In the present disclosure, the term “diffraction structure” may also mean “periodic structure” having a plurality of recessed parts or protruded parts arranged periodically. Note that, in some cases, depending on restriction on manufacture or other situations, the “diffraction structure” may include, in addition to the “periodic structure” an incomplete periodic structure.

### 1.1 Embodiment 1

### 1.1.1 Configurations

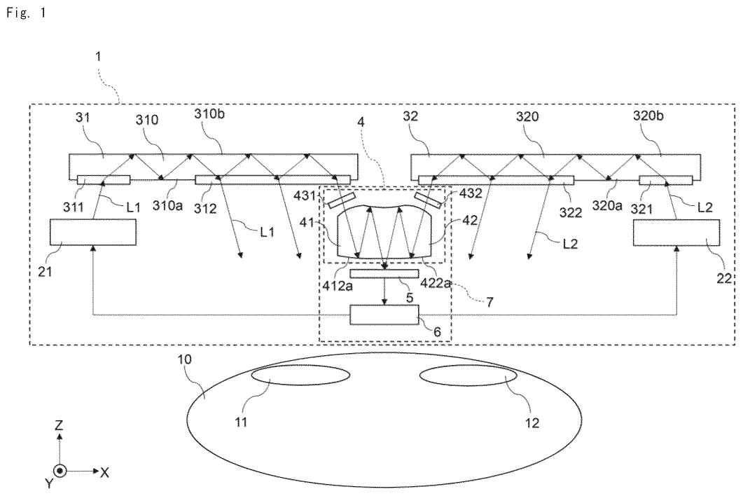

FIG. 1 is a schematic view of a configuration example of an image projection device 1 according to embodiment 1. The image projection device 1 projects images on a first eye 11 and a second eye 12 of an observer 10. The first eye 11 is the left eye and the second eye 12 is the right eye.

The image projection device 1 includes a first image unit 21, a second image unit 22, a first light guide 31, a second light guide 32, an optical system 4, an imaging element 5, and a detector 6. In the image projection device 1, the optical system 4, the imaging element 5, and the detector 6 constitute a display position detection device 7.

The first image unit 21 is configured to output a first light beam group L1 forming a first image to be projected on the first eye 11 of the observer 10. The first image unit 21 outputs the first image displayed on a display, by way of a projection optical system including an optical element such as a lens. The second image unit 22 is configured to output a second light beam group L2 forming a second image to be projected on the second eye 12 of the observer 10. The second image unit 22 outputs the second image displayed on a display, by way of a projection optical system including an optical element such as a lens. Only for simplification, the first light beam group L1 and the second light beam group L2 each are depicted as a single arrow, but in fact may be a light ray with an angle corresponding to a field of view angle.

The first image and the second image may be set appropriately in accordance with the purpose or the like, of the image projection device 1. For example, as the first image and the second image, images for augmented reality, virtual reality, or mixed reality may be used. In the present embodiment, the first image and the second image may be images superimposed or overlaid on the real world (real space). For example, the first image and the second image are set to artificially induce binocular disparity in the observer 10.

Examples of displays used in the first image unit 21 and the second image unit 22 may include known displays such as, a liquid crystal display, an organic EL display, a scanning MEMS mirror, LCOS (Liquid Crystal On Silicon), DMD (Digital Mirror Device), micro-LED, and SLM (Spatial Light Modulator).

The first and second light guides 31, 32 guide the first and second light beam groups L1, L2 output from the first and second image units 21, 22, toward the first and second eyes 11, 12 of the observer 10, respectively. The first and second light guides 31, 32 include first and second bodies 310, 320, first and second in-coupling regions 311, 321, and first and second reproduction regions 312, 322, respectively.

The first and second bodies 310, 320 are made of a material that is transparent in a visible light region. Therefore, the observer 10 can visually perceive a real world via the first and second bodies 310, 320. The first and second bodies 310, 320 have a plate shape. The first and second bodies 310, 320 include first surfaces 310a, 320a and second surfaces 310b, 320b in thickness directions of the first and second bodies 310, 320, respectively. The first and second bodies 310, 320 are positioned to direct the first surfaces 310a, 320a toward the observer 10, respectively.

The first and second in-coupling regions 311, 321 and the first and second reproduction regions 312, 321 are formed in or on the first surfaces 310a, 320a of the first and second bodies 310, 320, respectively.

The first in-coupling region 311 allows the first light beam group L1 to enter the first body 310 so that the first light beam group L1 propagates inside the first body 210 under a total internal reflection condition. For example, the first in-coupling region 311 allows the first light beam group L1 to enter the first body 310 so that the first light beam group L1 propagates inside the first body 310 in a first propagation direction (the +X direction) perpendicular to the thickness direction of the first body 310. The first in-coupling region 311 is used for coupling between the first image unit 21 and the first light guide 31. The term “coupling” used herein means allowing propagation inside the first body 310 of the first light guide 31 under a total internal reflection condition.

The first reproduction region 312 divides the first light beam group L1 propagating in the first propagation direction, into a plurality of first light beam groups L1 propagating in a second propagation direction (the −Y direction) intersecting the first propagation direction, in the first propagation direction. The first reproduction region 312 further divides the plurality of first light beam groups L1 propagating in the second propagation direction, into a plurality of first light beam groups L1 toward the observer 10, in the second propagation direction.

The first in-coupling region 311 and the first reproduction region 312 are constituted by diffraction structures causing diffraction effect for the first light beam group L1. The diffraction structures of the first in-coupling region 311 and the first reproduction region 312 are transmission surface-relief diffraction grating, for example. The diffraction structures of the first in-coupling region 311 and the first reproduction region 312 include recessed or protruded parts arranged periodically.

The first light guide 31 reproduces a pupil of the first light beam group L1 in the first propagation direction and the second propagation direction to expand the pupil, by dividing, inside the first body 310, the first light beam group L1 entering the first body 310 via the first in-coupling region 311, into a plurality of first light beam groups L1 arranged in the first propagation direction and propagating in the second propagation direction, and further dividing each first light beam group L1 into a plurality of first light beam groups L1 arranged in the second propagation direction and traveling toward the observer 10.

The second in-coupling region 321 allows the second light beam group L2 to enter the second body 320 so that the second light beam group L2 propagates inside the second body 320 under a total internal reflection condition. For example, the second in-coupling region 321 allows the second light beam group L2 to enter the second body 320 so that the second light beam group L2 propagates inside the second body 320 in a third propagation direction (the −X direction) perpendicular to the thickness direction of the second body 320. The second in-coupling region 321 is used for coupling between the second image unit 22 and the second light guide 32. The term “coupling” used herein means allowing propagation inside the second body 320 of the second light guide 32 under a total internal reflection condition.

The second reproduction region 322 divides the second light beam group L2 propagating in the third propagation direction, into a plurality of second light beam groups L2 propagating in a fourth propagation direction (the −Y direction) intersecting the third propagation direction, in the third propagation direction. The second reproduction region 322 further divides the plurality of second light beam groups L2 propagating in the fourth propagation direction, into a plurality of second light beam groups L2 toward the observer 10, in the fourth propagation direction.

The second in-coupling region 321 and the second reproduction region 322 are constituted by diffraction structures causing diffraction effect for the second light beam group L2. The diffraction structures of the second in-coupling region 321 and the second reproduction region 322 are transmission surface-relief diffraction grating, for example. The diffraction structures of the second in-coupling region 321 and the second reproduction region 322 include recessed or protruded parts arranged periodically.

The second light guide 32 reproduces a pupil of the second light beam group L2 in the third propagation direction and the fourth propagation direction to expand the pupil, by dividing, inside the second body 320, the second light beam group L2 entering the second body 320 via the second in-coupling region 321, into a plurality of second light beam groups L2 arranged in the third propagation direction and propagating in the fourth propagation direction, and further dividing each second light beam group L2 into a plurality of second light beam groups L2 arranged in the fourth propagation direction and traveling toward the observer 10.

In the present embodiment, one or some of the plurality of first light beam groups L1 traveling to the observer 10 from the first light guide 31 is incident on the optical system 4. One or some of the plurality of second light beam groups L2 traveling to the observer 10 from the second light guide 32 is incident on the optical system 4.

The image projection device 1 allows the first light beam group L1 from the first image unit 21 to be incident on the first eye 11 of the observer 10 by means of the first light guide 31, and allows the second light beam group L2 from the second image unit 22 to be incident on the second eye 12 of the observer 10 by means of the second light guide 32. The image projection device 1 projects the first image and the second image, which are different from each other, to the first eye 11 and the second eye 12 of the observer 10, thereby artificially inducing binocular disparity such that the observer 10 watches the image superimposed on the real world visually perceived through the first and second bodies 310, 320. The first light guide 31 reproduces and expand the pupil of the first light beam group L1 and the second light guide 32 reproduces and expand the pupil of the second light beam group L2. Therefore, the image projection device 1 can expand a field of view region allowing for the observer 10 to watch the first image and the second image.

Here, a relation between display positions of the first image and the second image may be set to match a positional relation thereof with regard to an object in a real world visually perceived by the observer 10 via the first and second bodies 310, 320. The display position detection device 7 is used for determining whether the relation between display positions of the first image by the first light beam group L1 and the second image by the second light beam L2 matches the positional relation thereof with regard to the real world visually perceived by the observer 10 via the first and second bodies 310, 320.

The display position detection device 7 includes the optical system 4, the imaging element 5, and the detector 6.

The optical system 4 is used to allow the first light beam group L1 forming the first image to be projected on the first eye 11 of the observer 10 and the second light beam group L2 forming the second image to be projected on the second eye 12 of the observer 10 to form images on an imaging plane 51.

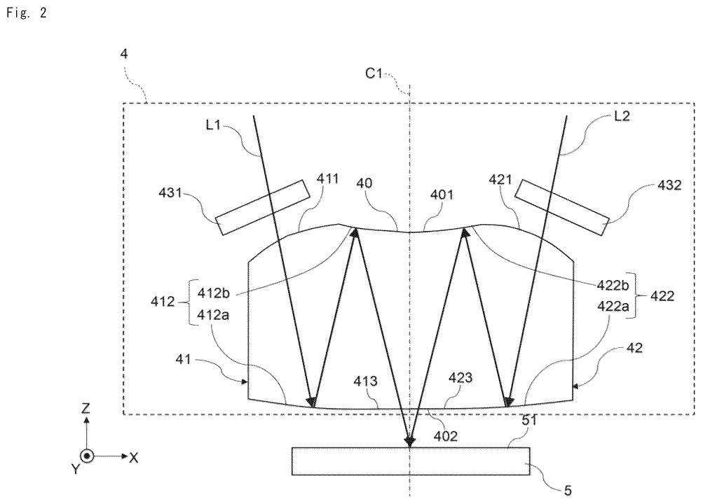

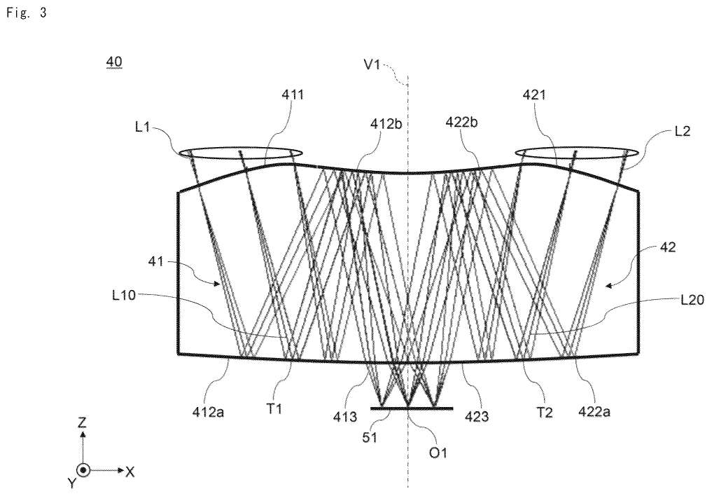

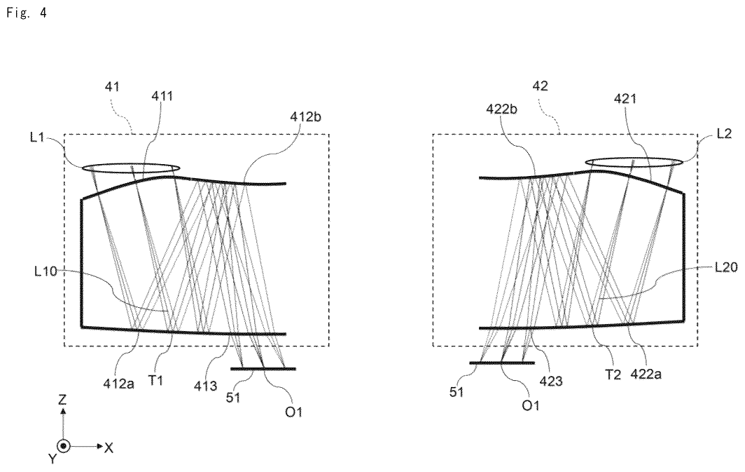

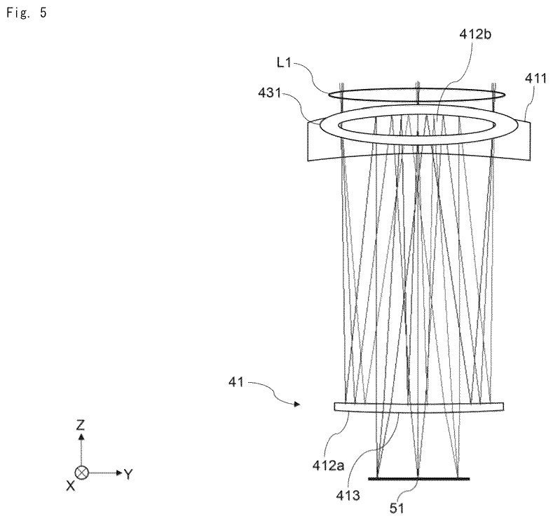

Hereinafter, the optical system 4 will be described in detail. FIG. 2 is a schematic view of the optical system 4. FIG. 3 is an explanatory view of an optical path of the optical system 4, viewed in the +Y direction. FIG. 4 is an explanatory view of optical paths of a first optical system 41 and a second optical system 42 of the optical system 4. FIG. 5 is an explanatory view of an optical path of the optical system 4, viewed in the −X direction.

The optical system 4 includes the first optical system 41, the second optical system 42, a first aperture stop 431, and a second aperture stop 432.

As shown in FIG. 3 to FIG. 5, the first optical system 41 allows the first light beam group L1 to form a first formation image on the imaging plane 51, and the second optical system 42 allows the second light beam group L2 to form a second formation image on the imaging plane 51. In FIG. 4, to easily distinguish the first light beam group L1 and the second light beam group L2 from each other, the first optical system 41 and the second optical system 42 are depicted as being separated in the left-right direction. FIG. 5 shows optical paths of the first light beam group L1 in a YZ plane. From FIG. 5, it is understood that the first optical system 41 allows the first light beam group L1 to converge on the imaging plane 51 even in the ±Y direction. As not illustrated in FIG. 5, the second optical system 42 allows the second light beam group L2 to converge on the imaging plane 51 even in the ±Y direction.

In the optical system 4, the first optical system 41 and the second optical system 42 are constituted by a prism 40. The prism 40 may be a prism made of a single part, or may be a prism formed by combining multiple parts.

The first optical system 41 includes a first incident surface 411, a first reflective surface group 412, and a first exit surface 413.

The first incident surface 411 is a transmissive surface which allows the first light beam group L1 to enter the prism 40. In the present embodiment, one or some of a plurality of first light beam groups L1 from the first light guide 31 toward the first eye 11 of the observer 10 enters the prism 40 from the first incident surface 411. Additionally, the first incident surface 411 has a convex shape toward a magnifying side. This allows the first light beam group L1 incident on the first incident surface 411 to converge inside the prism 40, and thus the prism 40 can be downsized. Further, the first incident surface 411 is a freeform surface a curvature of which becomes larger in the +X direction from a center and becomes smaller in the −X direction from the center. This makes it possible to effectively correct asymmetric aberrations caused by the first reflective surface group 412. The term “magnifying side” means an incident side of a light beam group in relation to a prism. The term “convex shape” for a transmissive surface means that the transmissive surface has a convex shape as a whole and may be allowed to partially include a concave or flat shape at a position not influencing a light beam group.

The first reflective surface group 412 reflects the first light beam group L1 inside the prism 40 to allow the first light beam group L1 to be incident on the imaging plane 51. The first reflective surface group 412 includes a first reflective surface 412a with a concave shape, and a third reflective surface 412b with a convex shape. The first reflective surface 412a reflects the first light beam group L1 so that it converges. Within the first reflective surface group 412, the first reflective surface 412a is located farthest from the imaging plane 51 along an optical path of the first light beam group L1. The third reflective surface 412b reflects the first light beam group L1 which has been reflected by the first reflective surface 412a. The term “concave shape” for a reflective surface means that the reflective surface has a concave shape as a whole and may be allowed to include a convex or flat shape at a position not influencing a light beam group. The term “convex shape” for a reflective surface means that the reflective surface has a convex shape as a whole and may be allowed to include a concave or flat shape at a position not influencing a light beam group.

The first exit surface 413 is a transmissive surface which allows the first light beam group L1 to emerge from the prism 40 toward the imaging plane 51.

The first optical system 41 includes the first incident surface 411, the first reflective surface 412a, the third reflective surface 412b, and the first exit surface 413 which are arranged in this order along the optical path of the first light beam group L1. Shapes and arrangement of the first incident surface 411, the first reflective surface 412a, the third reflective surface 412b, and the first exit surface 413 are set to allow the first light beam group L1 to be incident on the imaging plane 51. For example, at least one of the first incident surface 411, the first reflective surface 412a, the third reflective surface 412b, and the first exit surface 413 may include a freeform surface. The first optical system 41 allows the first light beam group L1 to converge from the magnifying side toward the reducing side and thereby from an image on the imaging plane 51. The magnifying side of the first optical system 41 is a side of the first incident surface 411 and the reducing side thereof is a side of the first exit surface 413.

The second optical system 42 includes a second incident surface 421, a second reflective surface group 422, and a second exit surface 423.

The second incident surface 421 is a transmissive surface which allows the second light beam group L2 to enter the prism 40. In the present embodiment, one or some of a plurality of second light beam groups L2 from the second light guide 32 toward the second eye 12 of the observer 10 enters the prism 40 from the second incident surface 421. Additionally, the second incident surface 421 has a convex shape toward a magnifying side. This allows the second light beam group L2 incident on the second incident surface 421 to converge inside the prism 40, and thus the prism 40 can be downsized. Further, the second incident surface 421 is a freeform surface a curvature of which becomes larger in the −X direction from a center and becomes smaller in the +X direction from the center. This makes it possible to effectively correct asymmetric aberrations caused by the second reflective surface group 422.

The second reflective surface group 422 reflects the second light beam group L2 inside the prism 40 to allow the second light beam group L2 to be incident on the imaging plane 51. The second reflective surface group 422 includes a second reflective surface 422a with a concave shape, and a fourth reflective surface 422b with a convex shape. The second reflective surface 422a reflects the second light beam group L2 so that it converges. Within the second reflective surface group 422, the second reflective surface 422a is located farthest from the imaging plane 51 along an optical path of the second light beam group L2. The fourth reflective surface 422b reflects the second light beam group L2 which has been reflected by the second reflective surface 422a.

The second exit surface 423 is a transmissive surface which allows the second light beam group L2 to emerge from the prism 40 toward the imaging plane 51.

The second optical system 42 includes the second incident surface 421, the second reflective surface 422a, the fourth reflective surface 422b, and the second exit surface 423 which are arranged in this order along the optical path of the second light beam group L2. Shapes and arrangement of the second incident surface 421, the second reflective surface 422a, the fourth reflective surface 422b, and the second exit surface 423 are set to allow the second light beam group L2 to be incident on the imaging plane 51. For example, at least one of the second incident surface 421, the second reflective surface 422a, the fourth reflective surface 422b, and the second exit surface 423 may include a freeform surface. The second optical system 42 allows the second light beam group L2 to converge from the magnifying side toward the reducing side and thereby from an image on the imaging plane 51. The magnifying side of the second optical system 42 is a side of the second incident surface 421 and the reducing side thereof is a side of the second exit surface 423.

As shown in FIG. 3, the first optical system 41 and the second optical system 42 allow the first light beam group L1 and the second light beam group L2 to be incident on the imaging plane 51 in different directions. The first optical system 41 and the second optical system 42 are configured to allow the first formation image and the second formation image to overlap each other within the imaging plane 51. In the present embodiment, the first optical system 41 and the second optical system 42 are set to allow an image point of the first optical system 41 and an image point of the second optical system 42 to coincide with the same position within the imaging plane 51. In other words, the first optical system 41 and the second optical system 42 are configured so that the first optical system 41 and the second optical system 42 have different magnifying side conjugate points but the first optical system 41 and the second optical system 42 have the same reducing side conjugate point.

As shown in FIG. 2, the first optical system 41 and the second optical system 42 are constituted by the prism 40. The +X direction, the −X direction, the +Y direction, the −Y direction, the +Z direction, and the −Z direction are the left direction, the right direction, the upward direction, the downward direction, the far side direction, and the front side direction, with regard to the observer 10. The ±X direction, the ±Y direction, and the ±Z direction are corresponding to a length direction, a width direction, and a thickness direction of the prism 40.

The prism 40 is made of a material that is transparent in a visible light region. The prism 40 includes a first surface 401 and a second surface 402 which face each other in the thickness direction (the ±Z direction). The first surface 401 and the second surface 402 span from an end in the +X direction to an end in the −X direction, of the prism 40. In the present embodiment, the prism 40 is located to allow the imaging plane 51 of the imaging element 5 to face the second surface 402. The second surface 402 is a transmissive surface which is part of the prism 40 and faces the imaging plane 51.

The first incident surface 411 of the first optical system 41 and the second incident surface 421 of the second optical system 42 are located within the same first surface 401 of the prism 40. The first incident surface 411 and the second incident surface 421 are regions which do not overlap each other. This can facilitate forming the prism 40 and allow its shape to be bilaterally symmetrical. The first incident surface 411 and the second incident surface 421 are located on opposite sides in the length direction (the ±X direction) in the first surface 401 of the prism 40.

The first reflective surface 412a of the first optical system 41 and the second reflective surface 422a of the second optical system 42 are located within the same second surface 402 being part of the prism 40 and facing each of the first incident surface 411 and the second incident surface 421. The first reflective surface 412a and the second reflective surface 422a are regions which do not overlap each other. This can facilitate forming the prism 40 and allow its shape to be bilaterally symmetrical. The first reflective surface 412a and the second reflective surface 422a are located on opposite side in the length direction (the ±X direction) in the second surface 402 of the prism 40.

The third reflective surface 412b of the first optical system 41 and the fourth reflective surface 422b of the second optical system 42 are located within the same first surface 401 being part of the prism 40 and facing each of the first reflective surface 412a and the second reflective surface 422a. The third reflective surface 412b and the fourth reflective surface 422b are regions which do not overlap each other. This can facilitate forming the prism 40 and allow its shape to be bilaterally symmetrical. The third reflective surface 412b and the fourth reflective surface 422b are located at a center in the length direction (the ±X direction) in the first surface 401 of the prism 40. In the present embodiment, the third reflective surface 412b and the fourth reflective surface 422b are located within the same first surface 401 as the first incident surface 411 and the second incident surface 421 are, but do not overlap the first incident surface 411 and the second incident surface 421.

The first exit surface 413 of the first optical system 41 and the second exit surface 423 of the second optical system 42 are located within the same second surface 402 being part of the prism 40 and facing each of the third reflective surface 412b and the fourth reflective surface 422b. The first exit surface 413 and the second exit surface 423 are regions which partially overlap each other. This allows decreasing a region of the prism 40 necessary for providing the first exit surface 413 and the second exit surface 423. The first exit surface 413 and the second exit surface 423 are located at a center in the length direction (the ±X direction) in the second surface 402 of the prism 40. In the present embodiment, the first exit surface 413 and the second exit surface 423 are located within the same second surface 402 as the first reflective surface 412a and the second reflective surface 422a are, but do not overlap the first reflective surface 412a and the second reflective surface 422a.

The first optical system 41 and the second optical system 42, which are described above, allow the first light beam group L1 and the second light beam group L2 to be incident on the imaging plane 51 in different directions. Therefore, it is possible to allow the first light beam group L1 and the second light beam group L2 to be incident on the same imaging plane 51, by use of the first optical system 41 and the second optical system 42.

Within a plane passing through (including) a perpendicular line V1 of the imaging plane 51, the first optical system 41 and the second optical system 42 are line-symmetric with regard to the perpendicular line V1 of the imaging plane 51. This does not intend to mean that the first optical system 41 and the second optical system 42 are line-symmetric with regard to the perpendicular line V1 of the imaging plane 51 within all of planes each passing through the perpendicular line V1 of the imaging plane 51, but to mean that the first optical system 41 and the second optical system 42 are line-symmetric with regard to the perpendicular line V1 of the imaging plane 51 within any of the planes each passing through the perpendicular line V1 of the imaging plane 51. In the present embodiment, the first optical system 41 and the second optical system 42 are line-symmetric with regard to the perpendicular line V1 of the imaging plane 51 within the XZ plane. In more detail, as shown in FIG. 3 and FIG. 4, within the first light beam group L1, a light beam reaching a center O1 of the imaging plane 51 is referred to as a first reference light beam L10, and within the second light beam group L2, a light beam reaching the center O1 of the imaging plane 51 is referred to as a second reference light beam L20. In a plane (the XZ plane in FIG. 3, FIG. 4) including the center O1 of the imaging plane 51, a first point T1 of the first reflective surface 412a at which the first reference light beam L10 is reflected, and a second point T2 of the second reflective surface 422a at which the second reference light beam L20 is reflected, the first optical system 41 and the second optical system 42 are line-symmetric with regard to the perpendicular line V1 passing through the center O1 of the imaging plane 51. Thus, the first optical system 41 and the second optical system 42 are line-symmetric with regard to a straight line C1 along the thickness direction (the ±Z direction) of the prism 40, when viewed in the width direction (the ±Y direction) (i.e., within the XZ plane). The straight line C1 may be aligned with the perpendicular line V1 passing through the center O1 of the imaging plane 51, for example. In this context, the phrase “the first optical system 41 and the second optical system 42 are line-symmetric” is not intended to mean that the first optical system 41 and the second optical system 42 are line-symmetric in the strict sense, but mean that the first optical system 41 and the second optical system 42 are line-symmetric to allow the optical path of the first light beam group L1 defined by the first optical system 41 and the optical path of the second light beam group L2 defined by the second optical system 42 to be line-symmetric. In other words, part of the first optical system 41 which does not influence the optical path of the first light beam group L1 and part of the second optical system 42 which does not influence the optical path of the second light beam group L2 may not be line-symmetric.

In other words, as shown in FIG. 2, the first optical system 41 and the second optical system 42 are line-symmetric with regard to the straight line C1 interconnecting a midpoint between the first eye 11 and the second eye 12, of the observer 10, and the imaging plane 51, within the XZ plane including the first eye 11 and the second eye 12, of the observer 10, as well as the imaging plane 51. This configuration allows application to configuration where light beam groups (the first light beam group L1 and the second light beam group L2) are incident in left and right directions. Especially, the optical system 4 can be easily applicable to configuration outputting light beam groups in left and right directions, such as a head-mounted display (HMD).

The first aperture stop 431 is located outside the prism 40 to face the first incident surface 411. In other words, the first aperture stop 431 is located on the magnifying side of the first incident surface 411. In more detail, the first aperture stop 431 is located on the magnifying side of the first incident surface 411 along the optical path of the first light beam group L1. The first aperture stop 431 is configured to limit a light beam incident on the first incident surface 411. A size of an aperture of the first aperture stop 431 is set to prohibit unnecessary light other than the first light beam group L1 from entering the first optical system 41. Providing the first aperture stop 431 can reduce the likelihood of unnecessary light entering the first optical system 41. Locating the first aperture stop 431 on the magnifying side of the first incident surface 411 can reduce an effective diameter of the first incident surface 411, resulting in preventing unnecessary light from entering the imaging plane 51.

The second aperture stop 432 is located outside the prism 40 to face the second incident surface 421. In other words, the second aperture stop 432 is located on the magnifying side of the second incident surface 421. In more detail, the second aperture stop 432 is located on the magnifying side of the second incident surface 421 along the optical path of the second light beam group L2. The second aperture stop 432 is configured to limit a light beam incident on the second incident surface 421. A size of an aperture of the second aperture stop 432 is set to prohibit unnecessary light other than the second light beam group L2 from entering the second optical system 42. Providing the second aperture stop 432 can reduce the likelihood of unnecessary light entering the second optical system 42. Locating the second aperture stop 432 on the magnifying side of the second incident surface 421 can reduce an effective diameter of the second incident surface 421, resulting in preventing unnecessary light from entering the imaging plane 51.

In the aforementioned optical system 4, the first optical system 41 allows the first light beam group L1 to form the first formation image on the imaging plane 51, by use of the first reflective surface group 412 (the first reflective surface 412a and the third reflective surface 412b). The second optical system 42 allows the second light beam group L2 to form the second formation image on the imaging plane 51, by use of the second reflective surface group 422 (the second reflective surface 422a and the fourth reflective surface 422b). Apparently, the optical system 4 does not include any optical element which causes large loss of light beam groups, such as a half mirror, and makes it possible to reduce loss of light beam groups (the first light beam group L1 and the second light beam group L2) allowed to be incident on the imaging plane 51.

The imaging element 5 includes the aforementioned imaging plane 51. The imaging element 5 may include an image sensor, for example. Examples of the image sensor may include a CMOS image sensor, a CCD image sensor, and the like.

The detector 6 is configured to perform a detection process. The detection process detects a positional relation between the first formation image P1 and the second formation image P2, from a positional relation between an image point of the first optical system 41 and an image point of the second optical system 42 based on the first formation image and the second formation image obtained from the imaging plane 51. The detector 6 enables confirmation of positional accuracies of the first formation image P1 and the second formation image P2. The detector 6 may be configured by a microcontroller including one or more microprocessors and memories, for example. The detector 6 may be configured by an FPGA (Field-Programmable Gate Array), an ASIC (Application Specific Integrated Circuit), or the like, for example.

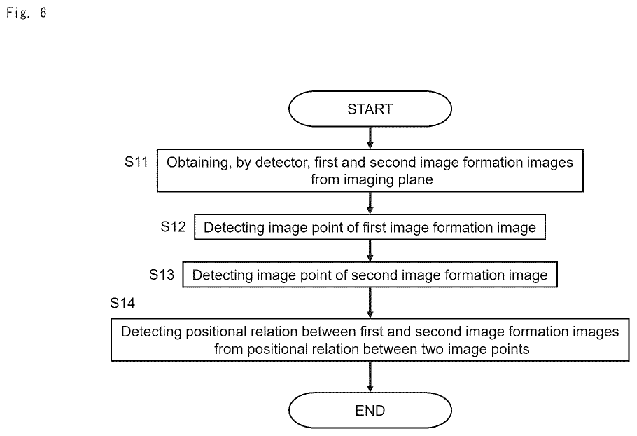

FIG. 6 is a flowchart of one example of the detection process by the detector 6.

The detector 6 obtains the first and second formation images from the imaging plane 51 (S11). For example, the detector 6 allows the first image unit 21 to output the first light beam group L1 and prohibits the second image unit 22 from outputting the second light beam group L2. By doing so, the detector 6 forms only the first formation image of the first formation image and the second formation image, on the imaging plane 51, and thus obtains the first formation image. Thereafter, the detector 6 allows the second image unit 22 to output the second light beam group L2 and prohibits the first image unit 21 from outputting the first light beam group L1. By doing so, the detector 6 forms only the second formation image of the first formation image and the second formation image, on the imaging plane 51, and thus obtains the second formation image.

The detector 6 detects the image point of the first formation image (S12). For example, the detector 6 specifies coordinates of the image point of the first formation image on the imaging plane 51. The image point of the first formation image corresponds to a reference position of the first formation image, for example. In the detection process, the first image unit 21 may project an image (e.g., images representing figures pointing out a reference position, or the like) indicative of a predetermined pattern which makes it easier to detect a central position of the first formation image. In this context, the reference position of the first formation image may be the central position of the first formation image or may be a predetermined position other than the central position.

The detector 6 detects the image point of the second formation image (S13). For example, the detector 6 specifies coordinates of the image point of the second formation image on the imaging plane 51. The image point of the second formation image corresponds to a reference position of the second formation image, for example. In the detection process, the second image unit 22 may project an image (e.g., images representing figures pointing out a reference position, or the like) indicative of a predetermined pattern which makes it easier to detect a central position of the second formation image. In this context, the reference position of the second formation image may be the central position of the second formation image or may be a predetermined position other than the central position.

The detector 6 detects the positional relation between the first formation image and the second formation image, from the positional relation between the image point of the first formation image and the image point of the second formation image (S14). For example, the detector 6 can detect how the first formation image and the second formation image are deviated from each other, from the coordinates of the image point of the first formation image on the imaging plane 51 and the coordinates of the image point of the second formation image on the imaging plane 51.

By the detector 6, it is possible to obtain the positional relation between the first formation image and the second formation image. The positional relation between the first formation image and the second formation image is used in a calibration process. The calibration process is a process of allowing a relation between the display positions of the first image by the first light beam group L1 and the second image by the second light beam group L2 to satisfy a condition of the observer 10 capable of visually perceiving a 3D image.

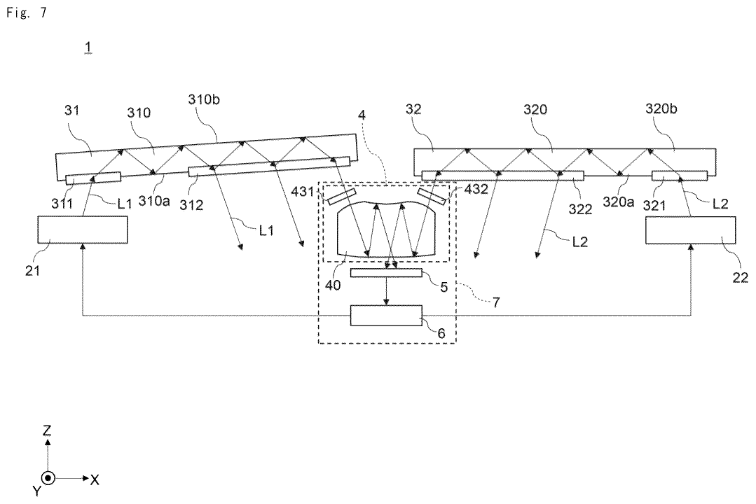

FIG. 7 is an explanatory diagram of one example of the calibration process of the image projection device 1. In FIG. 7, a position of the first light guide 31 is displaced from a target position. A displacement of the position of the first light guide 31 from the target position may result in a displacement between display positions of the first image by the first light beam group L1 and the second image by the second light beam group L2. The displacement between the display positions of the first image and the second image may cause a deterioration in the quality of the image visually perceived by the observer 10.

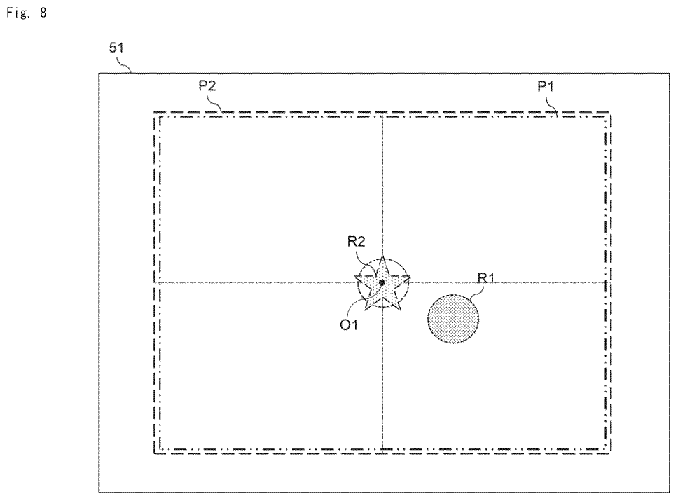

FIG. 8 is an explanatory diagram of examples of the first formation image and the second formation image according to the example of FIG. 7. In the display position detection device 7, the first formation image P1 and the second formation image P2 are displayed so that they overlap each other in the imaging plane 51. Further, a reference position R1 (e.g., a central position) of an image projected by the first image unit 21 is set to be located at a central part of the first formation image P1 and a reference position R2 (e.g., a central position) of an image projected by the second image unit 22 is set to be located at a central part of the second formation image P2. When the first image unit 21 and the second image unit 22 project images indicative of the reference positions R1, R2, respectively, the reference position R1 of the first formation image P1 and the reference position R2 of the second formation image P2 completely overlap each other at the center O1 of the imaging plane 51. It is possible to detect that the display positions of the first formation image P1 and the second formation image P2 are correct positions. In FIG. 8, the reference position R1 of the first formation image P1 is displaced from the center O1 of the imaging plane 51 in the lower right direction. In contrast, the reference position R2 of the second formation image P2 is located at the center O1 of the imaging plane 51. Therefore, the reference position R1 of the first formation image P1 and the reference position R2 of the second formation image P2 do not coincide with each other. In such a case, the quality of the image visually perceived by the observer 10 may be deteriorated.

In this case, settings of the first image unit 21 may be changed to allow the reference position R1 of the first formation image P1 to be located at the center O1 of the imaging plane 51.

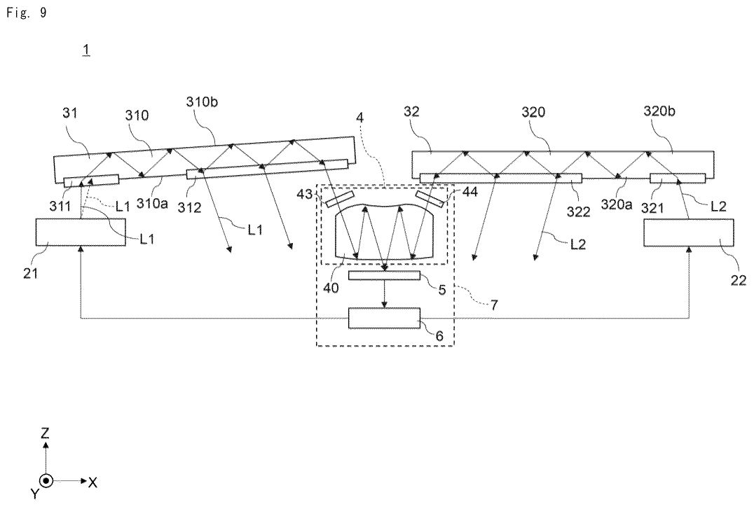

FIG. 9 is an explanatory diagram of one example of the calibration process of the image projection device 1. In FIG. 9, the optical axis of the first light beam group L1 emerging from the first image unit 21 is adjusted from a dotted line to a solid line. Adjustment of the optical axis of the first light beam group L1 enables movement of the reference position R1 of the first formation image to the center O1 of the imaging plane 51 within the imaging plane 51. The adjustment of the optical axis of the first light beam group L1 can be realized by use of reflectors or the like.

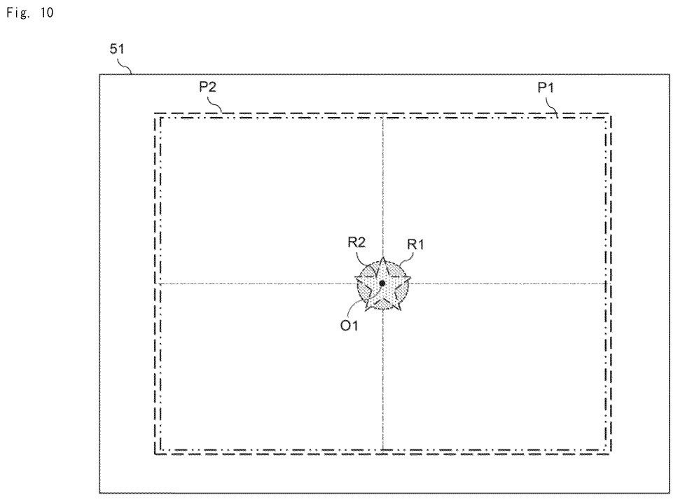

FIG. 10 is an explanatory diagram of examples of the first formation image and the second formation image according to the example of FIG. 9. In FIG. 10, the reference position R1 of the first formation image P1 is located at the center O1 of the imaging plane 51, and similarly the reference position R2 of the second formation image P2 is located at the center O1 of the imaging plane 51. Therefore, the reference position R1 of the first formation image P1 and the reference position R2 of the second formation image P2 coincide with each other. In such a case, the quality of the image visually perceived by the observer 10 can be improved.

Herein, an overlap between the first formation image P1 and the second formation image P2 enables downsizing the optical system 4 and it is possible to satisfy the needs for decreases in the size and weight required for head-mounted displays. It is necessary to consider the magnitude of displacement so that the first and second reference positions R1, R2 are displayed within the formation images even if they are displaced within the first and second formation images P1, P2. Therefore, a size of an overlap between the first formation image P1 and the second formation image P2 may preferably be equal to or larger than 20%, more preferably 50%, of a size of the first formation image P1 or the second formation image P2. This configuration enables confirming an overlap between the image point of the first optical system 41 and the image point of the second optical system 42 by images.

### 1.1.2 Advantageous Effects

The aforementioned optical system 4, in a first configuration, allows, in relation to the image projection device 1 projecting images on eyes of the observer 10, the first light beam group L1 forming a first image to be projected on the first eye 11 of the observer 10 and the second light beam group L2 forming a second image to be projected on the second eye 12 of the observer 10, to form images on the imaging plane 51. The optical system 4 includes the first optical system 41 for allowing the first light beam group L1 to form the first formation image P1 on the imaging plane 51 and the second optical system 42 for allowing the second light beam group L2 to form the second formation image P2 on the imaging plane 51. The first optical system 41 includes the first reflective surface group 412 which reflects the first light beam group L1 to allow the first light beam group L1 to be incident on the imaging plane 51 and includes at least the first reflective surface 412a with a concave shape. The second optical system 42 includes the second reflective surface group 422 which reflects the second light beam group L2 to allow the second light beam group L2 to be incident on the imaging plane 51 and includes at least the second reflective surface 422a with a concave shape. The first formation image P1 and the second formation image P2 overlap each other within the imaging plane 51. This configuration enables reducing loss of the first light beam group L1 and the second light beam group L2 to be incident on the imaging plane 51.

In the optical system 4, the first optical system 41 and the second optical system 42 allow the first light beam group L1 and the second light beam group L2 to be incident on the imaging plane 51 in different directions. This configuration makes it possible to allow the first light beam group L1 and the second light beam group L2 to be incident on the same imaging plane 51, by use of the first optical system 41 and the second optical system 42.

In the optical system 4, within a plane passing through the perpendicular line V1 of the imaging plane 51, the first optical system 41 and the second optical system 42 are line-symmetric with regard to the perpendicular line V1 of the imaging plane 51. This configuration allows application to configuration where light beam groups are incident in left and right directions.

In the optical system 4, within the first reflective surface group 412, the first reflective surface 412a is located farthest from the imaging plane 51 along the optical path of the first light beam group L1. Within the second reflective surface group 422, the second reflective surface 422a is located farthest from the imaging plane 51 along the optical path of the second light beam group L2. This configuration allows the first light beam group L1 and the second light beam group L2 to converge from the magnifying side toward the reducing side and thereby from images on the imaging plane 51.

In the optical system 4, the first reflective surface group 412 includes the third reflective surface 412b with a convex shape which reflects the first light beam group L1 which has been reflected by the first reflective surface 412a; and the second reflective surface group 422 includes the fourth reflective surface 422b with a convex shape which reflects the second light beam group L2 which has been reflected by the second reflective surface 422a. This configuration allows the first light beam group L1 and the second light beam group L2 to converge from the magnifying side toward the reducing side and thereby from images on the imaging plane 51.

In the optical system 4, the first optical system 41 and the second optical system 42 are constituted by the prism 40. The first optical system 41 further includes the first incident surface 411 allowing the first light beam group L1 to enter the prism 40 and the first exit surface 413 allowing the first light beam group L1 to emerge from the prism 40 to the imaging plane 51. The first reflective surface group 412 reflects the first light beam group L1 inside the prism 40. The second optical system 42 further includes the second incident surface 421 allowing the second light beam group L2 to enter the prism 40 and the second exit surface 423 allowing the second light beam group L2 to emerge from the prism 40 to the imaging plane 51. The second reflective surface group 422 reflects the second light beam group L2 inside the prism 40. This configuration enables integrated molding of the first optical system 41 and the second optical system 42 as well as downsizing them.

In the optical system 4, the optical system 4 further includes the first aperture stop 431 located outside the prism 40 to face the first incident surface 411 and the second aperture stop 432 located outside the prism 40 to face the second incident surface 421. This configuration can reduce the likelihood of unnecessary light entering the first optical system 41 and the second optical system 42.

In the optical system 4, the first exit surface 413 and the second exit surface 423 are located within a transmissive surface which is part of the prism 40 and faces the imaging plane 51, and are regions which partially overlap each other. This configuration allows decreasing a region of the prism 40 necessary for providing the first exit surface 413 and the second exit surface 423

In the optical system 4, the first reflective surface group 412 includes the third reflective surface 412b with a convex shape which reflects the first light beam group L1 which has been reflected by the first reflective surface 412a. The second reflective surface group 422 includes the fourth reflective surface 422b with a convex shape which reflects the second light beam group L2 which has been reflected by the second reflective surface 422a. The third reflective surface 412b and the fourth reflective surface 422b are located within the same first surface 401 being part of the prism 40 and facing the first exit surface 413 and the second exit surface 423, and are regions which do not overlap each other. This configuration can facilitate forming the prism 40 and allow its shape to be bilaterally symmetrical.

In the optical system 4, the first reflective surface 412a and the second reflective surface 422a are located within the same second surface 402 being part of the prism and facing each of the first incident surface 411 and the second incident surface 421, and are regions which do not overlap each other. This configuration can facilitate forming the prism 40 and allow its shape to be bilaterally symmetrical.

In the optical system 4, at least one of the first incident surface 411, the first reflective surface group 412, the first exit surface 413, the second incident surface 421, the second reflective surface group 422, or the second exit surface 423 includes a freeform surface. This configuration enables improvement of the degree of freedom of the design of the prism 40.

In the optical system 4, the size of the overlap between the first formation image P1 and the second formation image P2 within the imaging plane 51 is equal to or larger than 20% of the size of the first formation image P1 or the second formation image P2. This configuration enables confirming an overlap between the image point of the first optical system 41 and the image point of the second optical system 42 by images.

The aforementioned image projection device 1 includes: the optical system 4;

the first image unit 21 configured to output the first light beam group L1; and the second image unit 22 configured to output the second light beam group L2. This configuration enables reducing loss of the first light beam group L1 and the second light beam group L2 to be incident on the imaging plane 51.

The aforementioned display position detection device 7 includes: the optical system 4; and the detector 6 configured to detect the positional relation between the first formation image P1 and the second formation image P2, from the positional relation between the image point of the first optical system 41 and the image point of the second optical system 42 based on the first formation image P1 and the second formation image P2 obtained from the imaging plane 51. This configuration enables confirming position accuracy of the first formation image P1 and the second formation image P2.

### 1.2 Embodiment 2

### 1.2.1 Configuration

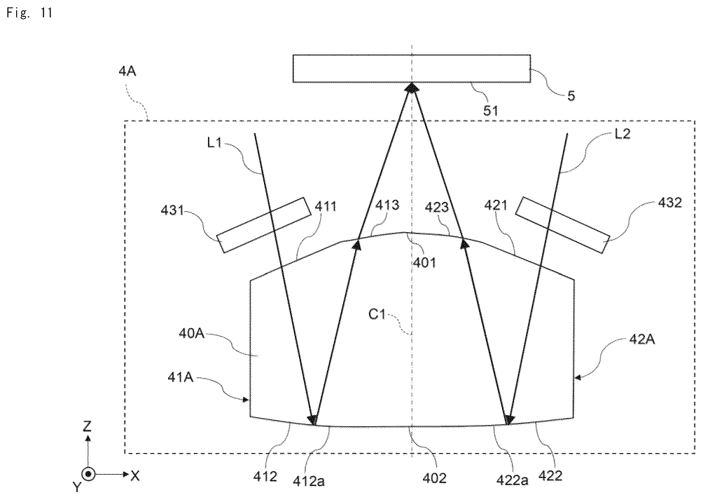

FIG. 11 is a schematic view of a configuration example of an optical system 4A of an image projection device according to embodiment 2. The optical system 4A of embodiment 2 can be used in the image projection device 1 of embodiment 1, as an alternative to the optical system 4.

The optical system 4A includes a first optical system 41A, a second optical system 42A, the first aperture stop 431, and the second aperture stop 432.

In the optical system 4A of FIG. 11, the first optical system 41A and the second optical system 42A are constituted by a prism 40A.

The first optical system 41A includes the first incident surface 411, the first reflective surface group 412, and the first exit surface 413. The first reflective surface group 412 includes the first reflective surface 412a with a concave shape. The first reflective surface 412a reflects the first light beam group L1 so that it converges.

The first optical system 41A includes the first incident surface 411, the first reflective surface 412a, and the first exit surface 413 which are arranged in this order along the optical path of the first light beam group L1. Shapes and arrangement of the first incident surface 411, the first reflective surface 412a, and the first exit surface 413 are set to allow the first light beam group L1 to be incident on the imaging plane 51. For example, at least one of the first incident surface 411, the first reflective surface 412a, and the first exit surface 413 may include a freeform surface.

The second optical system 42A includes the second incident surface 421, the second reflective surface group 422, and the second exit surface 423. The second reflective surface group 422 includes the second reflective surface 422a with a concave shape. The second reflective surface 422a reflects the second light beam group L2 so that it converges.

The second optical system 42A includes the second incident surface 421, the second reflective surface 422a, and the second exit surface 423 which are arranged in this order along the optical path of the second light beam group L2. Shapes and arrangement of the second incident surface 421, the second reflective surface 422a, and the second exit surface 423 are set to allow the second light beam group L2 to be incident on the imaging plane 51. For example, at least one of the second incident surface 421, the second reflective surface 422a, and the second exit surface 423 may include a freeform surface.

The first optical system 41A and the second optical system 42A are constituted by the prism 40A.

The prism 40A includes the first surface 401 and the second surface 402 which face each other in the thickness direction (the ±Z direction). The first surface 401 and the second surface 402 span from one end in the +X direction to the other end in the −X direction, of the prism 40A. In the present embodiment, the prism 40A is located to allow the imaging plane 51 of the imaging element 5 to face the first surface 401. The first surface 401 is a transmissive surface which is part of the prism 40A and faces the imaging plane 51.

The first incident surface 411 of the first optical system 41A and the second incident surface 421 of the second optical system 42A are located within the same first surface 401 of the prism 40A. The first incident surface 411 and the second incident surface 421 are regions which do not overlap each other. This configuration can facilitate forming the prism 40A and allow its shape to be bilaterally symmetrical. The first incident surface 411 and the second incident surface 421 are located on opposite sides in the length direction (the ±X direction) in the first surface 401 of the prism 40A.

The first reflective surface 412a of the first optical system 41A and the second reflective surface 422a of the second optical system 42A are located within the same second surface 402 being part of the prism 40A and facing each of the first incident surface 411 and the second incident surface 421. The first reflective surface 412a and the second reflective surface 422a are regions which do not overlap each other. This can facilitate forming the prism 40A and allow its shape to be bilaterally symmetrical. The first reflective surface 412a and the second reflective surface 422a are located on opposite side in the length direction (the ±X direction) in the second surface 402 of the prism 40A.

The first exit surface 413 of the first optical system 41A and the second exit surface 423 of the second optical system 42A are located within the same first surface 401 being part of the prism 40A and facing each of the first reflective surface 412a and the second reflective surface 422a. The first exit surface 413 and the second exit surface 423 are regions which partially overlap each other. This allows decreasing a region of the prism 40A necessary for providing the first exit surface 413 and the second exit surface 423. The first exit surface 413 and the second exit surface 423 are located at a center in the length direction (the ±X direction) in the first surface 401 of the prism 40A. In the present embodiment, the first exit surface 413 and the second exit surface 423 are located within the same first surface 401 as the first incident surface 411 and the second incident surface 421 are, but do not overlap the first incident surface 411 and the second incident surface 421.

The first optical system 41A and the second optical system 42A, which are described above, allow the first light beam group L1 and the second light beam group L2 to be incident on the imaging plane 51 in different directions. Therefore, it is possible to allow the first light beam group L1 and the second light beam group L2 to be incident on the same imaging plane 51, by use of the first optical system 41A and the second optical system 42A.

The first optical system 41A and the second optical system 42A are line-symmetric in a manner similar to the first optical system 41 and the second optical system 42. This configuration allows application to configuration where light beam groups (the first light beam group L1 and the second light beam group L2) are incident in left and right directions. Especially, the optical system 4A can be easily applicable to configuration outputting light beam groups in left and right directions, such as a head-mounted display (HMD).

In the aforementioned optical system 4A, the first optical system 41A allows the first light beam group L1 to form the first formation image on the imaging plane 51, by use of the first reflective surface group 412 (the first reflective surface 412a). The second optical system 42A allows the second light beam group L2 to form the second formation image on the imaging plane 51, by use of the second reflective surface group 422 (the second reflective surface 422a). Apparently, the optical system 4A does not include any optical element which causes large loss of light beam groups, such as a half mirror, and makes it possible to reduce loss of light beam groups (the first light beam group L1 and the second light beam group L2) allowed to be incident on the imaging plane 51.

### 1.2.2 Advantageous Effects

The aforementioned optical system 4A allows, in relation to the image projection device 1 projecting images on eyes of the observer 10, the first light beam group L1 forming a first image to be projected on the first eye 11 of the observer 10 and the second light beam group L2 forming a second image to be projected on the second eye 12 of the observer 10, to form images on the imaging plane 51. The optical system 4A includes the first optical system 41A for allowing the first light beam group L1 to form the first formation image P1 on the imaging plane 51 and the second optical system 42A for allowing the second light beam group L2 to form the second formation image P2 on the imaging plane 51. The first optical system 41A includes the first reflective surface group 412 which reflects the first light beam group L1 to allow the first light beam group L1 to be incident on the imaging plane 51 and includes at least the first reflective surface 412a with a concave shape. The second optical system 42A includes the second reflective surface group 422 which reflects the second light beam group L2 to allow the second light beam group L2 to be incident on the imaging plane 51 and includes at least the second reflective surface 422a with a concave shape. The first formation image P1 and the second formation image P2 overlap each other within the imaging plane 51. This configuration enables reducing loss of the first light beam group L1 and the second light beam group L2 to be incident on the imaging plane 51.

### 1.3 Embodiment 3

### 1.3.1 Configuration

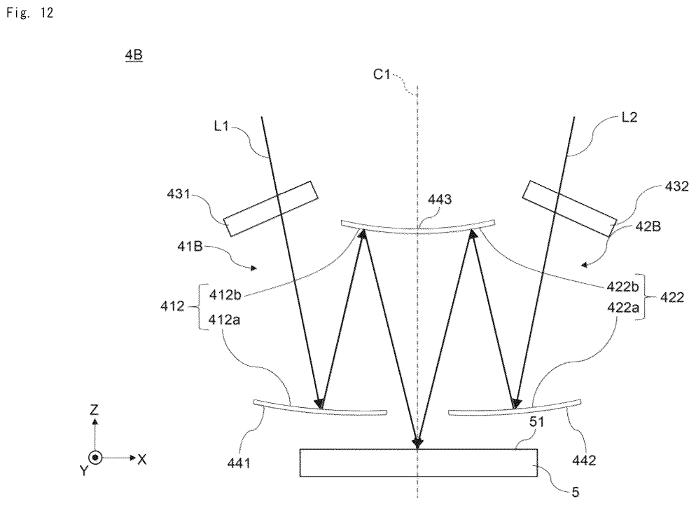

FIG. 12 is a schematic view of a configuration example of an optical system 4B of an image projection device according to embodiment 3. The optical system 4B of embodiment 3 can be used in the image projection device 1 of embodiment 1, as an alternative to the optical system 4.

The optical system 4B includes a first optical system 41B, a second optical system 42B, the first aperture stop 431, and the second aperture stop 432.

The optical system 4B includes a first optical system 41B, and a second optical system 42B.

In the optical system 4B, the first optical system 41B and the second optical system 42B are constituted by a plurality of reflective plates 441, 442, and 443.

The first optical system 41B includes the first reflective surface group 412. The first reflective surface group 412 includes the first reflective surface 412a with a concave shape and the third reflective surface 412b with a convex shape.

The first optical system 41B includes the first reflective surface 412a and the third reflective surface 412b which are arranged in this order along the optical path of the first light beam group L1. Shapes and arrangement of the first reflective surface 412a and the third reflective surface 412b are set to allow the first light beam group L1 to be incident on the imaging plane 51. For example, at least one of the first reflective surface 412a and the third reflective surface 412b may include a freeform surface.

The second optical system 42B includes the second reflective surface group 422. The second reflective surface group 422 includes the second reflective surface 422a with a concave shape and the fourth reflective surface 422b with a convex shape.

The second optical system 42B includes the second reflective surface 422a and the fourth reflective surface 422b which are arranged in this order along the optical path of the second light beam group L2. Shapes and arrangement of the second reflective surface 422a and the fourth reflective surface 422b are set to allow the second light beam group L2 to be incident on the imaging plane 51. For example, at least one of the second reflective surface 422a and the fourth reflective surface 422b may include a freeform surface.

The first optical system 41B and the second optical system 42B allow the first light beam group L1 and the second light beam group L2 to be incident on the imaging plane 51 in different directions. The first optical system 41B and the second optical system 42B are configured to allow the first formation image and the second formation image to overlap each other within the imaging plane 51. In the present embodiment, the first optical system 41B and the second optical system 42B are set to allow the image point of the first optical system 41B and the image point of the second optical system 42B to coincide with the same position within the imaging plane 51.

The first optical system 41B and the second optical system 42B are constituted by the plurality of reflective plates 441, 442, and 443.

The plurality of reflective plates 441, 442, and 443 are mirrors, for example. The reflective plate 441 defines the first reflective surface 412a of the first optical system 41B. The reflective plate 442 defines the second reflective surface 422a of the second optical system 42B. The reflective plate 443 defines the third reflective surface 412b of the first optical system 41B and the fourth reflective surface 422b of the second optical system 42B. The reflective plate 443 is located to face the imaging plane 51 of the imaging element 5. The reflective plates 441 and 442 are located between the imaging plane 51 and the reflective plate 443 in the ±Z direction, and are located separate from each other in the ±X direction to form a gap between the reflective plates 441 and 442 to allow the first light beam group L1 and the second light beam group L2 from the reflective plate 443 to pass through the gap.

The first optical system 41B and the second optical system 42B, which are described above, allow the first light beam group L1 and the second light beam group L2 to be incident on the imaging plane 51 in different directions. Therefore, it is possible to allow the first light beam group L1 and the second light beam group L2 to be incident on the same imaging plane 51, by use of the first optical system 41B and the second optical system 42B.

The first optical system 41B and the second optical system 42B are line-symmetric in a manner similar to the first optical system 41 and the second optical system 42. This configuration allows application to configuration where light beam groups (the first light beam group L1 and the second light beam group L2) are incident in left and right directions. Especially, the optical system 4B can be easily applicable to configuration outputting light beam groups in left and right directions, such as a head-mounted display (HMD).

The first aperture stop 431 is located to face the first incident surface 411 with regard to the reflective plate 441. The second aperture stop 432 is located to face the second incident surface 421 with regard to the reflective plate 442. Providing the first and second aperture stops 431 and 432 can reduce the likelihood of unnecessary light entering the first and second optical systems 41 and 42.

In the aforementioned optical system 4B, the first optical system 41B allows the first light beam group L1 to form the first formation image on the imaging plane 51, by use of the first reflective surface group 412 (the first reflective surface 412a and the third reflective surface 412b). The second optical system 42B allows the second light beam group L2 to form the second formation image on the imaging plane 51, by use of the second reflective surface group 422 (the second reflective surface 422a and the fourth reflective surface 422b). Apparently, the optical system 4B does not include any optical element which causes large loss of light beam groups, such as a half mirror, and makes it possible to reduce loss of light beam groups (the first light beam group L1 and the second light beam group L2) allowed to be incident on the imaging plane 51.

### 1.3.2 Advantageous Effects

The aforementioned optical system 4B allows, in relation to the image projection device 1 projecting images on eyes of the observer 10, the first light beam group L1 forming a first image to be projected on the first eye 11 of the observer 10 and the second light beam group L2 forming a second image to be projected on the second eye 12 of the observer 10, to form images on the imaging plane 51. The optical system 4B includes the first optical system 41B for allowing the first light beam group L1 to form the first formation image P1 on the imaging plane 51 and the second optical system 42B for allowing the second light beam group L2 to form the second formation image P2 on the imaging plane 51. The first optical system 41B includes the first reflective surface group 412 which reflects the first light beam group L1 to allow the first light beam group L1 to be incident on the imaging plane 51 and includes at least the first reflective surface 412a with a concave shape. The second optical system 42B includes the second reflective surface group 422 which reflects the second light beam group L2 to allow the second light beam group L2 to be incident on the imaging plane 51 and includes at least the second reflective surface 422a with a concave shape. The first formation image P1 and the second formation image P2 overlap each other within the imaging plane 51. This configuration enables reducing loss of the first light beam group L1 and the second light beam group L2 to be incident on the imaging plane 51.

### 1.4 Embodiment 4

### 1.4.1 Configuration

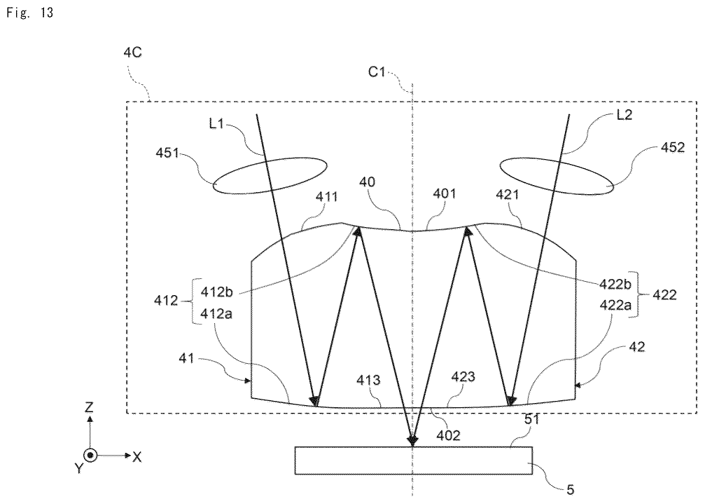

FIG. 13 is a schematic view of a configuration example of an optical system 4C of an image projection device according to embodiment 4. The optical system 4C of embodiment 4 can be used in the image projection device 1 of embodiment 1, as an alternative to the optical system 4.

The optical system 4C includes the first optical system 41, the second optical system 42, a first converging optical system 451, and a second converging optical system 452.

The first converging optical system 451 is located outside the prism 40 to face the first incident surface 411. In other words, the first converging optical system 451 is located on the magnifying side of the first incident surface 411 along the optical path of the first light beam group L1. The first converging optical system 451 includes one or more optical elements, for example. Examples of the one or more optical elements may include, but are not limited to, a converging lens. The first converging optical system 451 allows the first light beam group L1 to converge on the first incident surface 411. Providing the first converging optical system 451 enables downsizing the first optical system 41.

The second converging optical system 452 is located outside the prism 40 to face the second incident surface 421. In other words, the second converging optical system 452 is located on the magnifying side of the second incident surface 421 along the optical path of the second light beam group L2. The second converging optical system 452 includes one or more optical elements, for example. Examples of the one or more optical elements may include, but are not limited to, a converging lens. The second converging optical system 452 allows the second light beam group L2 to converge on the second incident surface 421. Providing the second converging optical system 452 enables downsizing the second optical system 42.

### 1.4.2 Advantageous Effects

The aforementioned optical system 4C allows, in relation to the image projection device 1 projecting images on eyes of the observer 10, the first light beam group L1 forming a first image to be projected on the first eye 11 of the observer 10 and the second light beam group L2 forming a second image to be projected on the second eye 12 of the observer 10, to form images on the imaging plane 51. The optical system 4C includes the first optical system 41 for allowing the first light beam group L1 to form the first formation image P1 on the imaging plane 51 and the second optical system 42 for allowing the second light beam group L2 to form the second formation image P2 on the imaging plane 51. The first optical system 41 includes the first reflective surface group 412 which reflects the first light beam group L1 to allow the first light beam group L1 to be incident on the imaging plane 51 and includes at least the first reflective surface 412a with a concave shape. The second optical system 42 includes the second reflective surface group 422 which reflects the second light beam group L2 to allow the second light beam group L2 to be incident on the imaging plane 51 and includes at least the second reflective surface 422a with a concave shape. The first formation image P1 and the second formation image P2 overlap each other within the imaging plane 51. This configuration enables reducing loss of the first light beam group L1 and the second light beam group L2 to be incident on the imaging plane 51.

### 1.5 Embodiment 5

### 1.5.1 Configuration

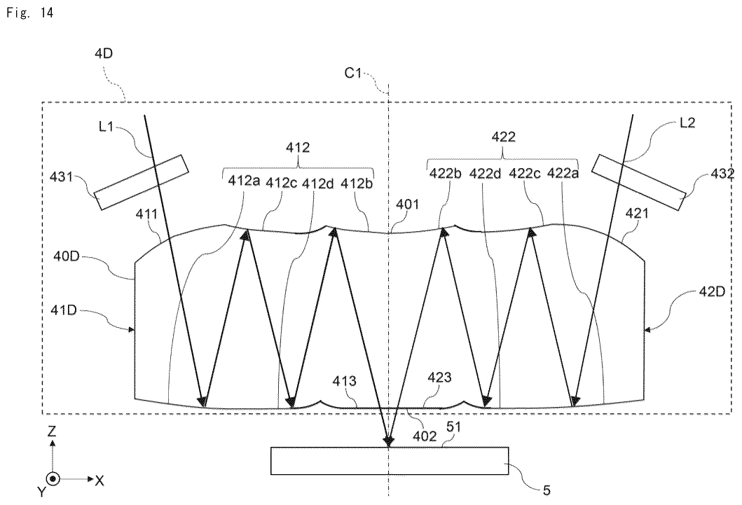

FIG. 14 is a schematic view of a configuration example of an optical system 4D of an image projection device according to embodiment 5. The optical system 4D of embodiment 5 can be used in the image projection device 1 of embodiment 1, as an alternative to the optical system 4.

The optical system 4D includes a first optical system 41D, a second optical system 42D, the first aperture stop 431, and the second aperture stop 432.

In the optical system 4D, the first optical system 41D and the second optical system 42D are constituted by a prism 40D.

The first optical system 41D includes the first incident surface 411, the first reflective surface group 412, and the first exit surface 413.

The first reflective surface group 412 includes the first reflective surface 412a with a concave shape, the third reflective surface 412b with the convex shape, a fifth reflective surface 412c, and a seventh reflective surface 412d. The fifth reflective surface 412c reflects the first light beam group L1 from the first reflective surface 412a toward the seventh reflective surface 412d. The seventh reflective surface 412d reflects the first light beam group L1 from the fifth reflective surface 412c toward the third reflective surface 412b. The first reflective surface group 412 further includes the fifth reflective surface 412c and the seventh reflective surface 412d and therefore makes it possible to increase a distance between the first incident surface 411 and the first exit surface 413 in the ±X direction. This can improve the degree of freedom of arrangement of the first image unit 21 and the imaging element 5.

The first optical system 41D includes the first incident surface 411, the first reflective surface 412a, the fifth reflective surface 412c, the seventh reflective surface 412d, the third reflective surface 412b, and the first exit surface 413 which are arranged in this order along the optical path of the first light beam group L1. Shapes and arrangement of the first incident surface 411, the first reflective surface 412a, the fifth reflective surface 412c, the seventh reflective surface 412d, the third reflective surface 412b, and the first exit surface 413 are set to allow the first light beam group L1 to be incident on the imaging plane 51. For example, at least one of the first incident surface 411, the first reflective surface group 412 (the first reflective surface 412a, the third reflective surface 412b, the fifth reflective surface 412c, the seventh reflective surface 412d), and the first exit surface 413 may include a freeform surface.

The second optical system 42D includes the second incident surface 421, the second reflective surface group 422, and the second exit surface 423.

The second reflective surface group 422 includes the second reflective surface 422a with a concave shape, the fourth reflective surface 422b with a convex shape, a sixth reflective surface 422c, and an eighth reflective surface 422d. The sixth reflective surface 422c reflects the second light beam group L2 from the second reflective surface 422a toward the eighth reflective surface 422d. The eighth reflective surface 422d reflects the second light beam group L2 from the sixth reflective surface 422c toward the fourth reflective surface 422b. The second reflective surface group 422 further includes the sixth reflective surface 422c and the eighth reflective surface 422d, and therefore makes it possible to increase a distance between the second incident surface 421 and the second exit surface 423 in the ±X direction. This can improve the degree of freedom of arrangement of the second image unit 22 and the imaging element 5.

The second optical system 42D includes the second incident surface 421, the second reflective surface 422a, the sixth reflective surface 422c, the eighth reflective surface 422d, the fourth reflective surface 422b, and the second exit surface 423 which are arranged in this order along the optical path of the second light beam group L2. Shapes and arrangement of the second incident surface 421, the second reflective surface 422a, the sixth reflective surface 422c, the eighth reflective surface 422d, the fourth reflective surface 422b, and the second exit surface 423 are set to allow the second light beam group L2 to be incident on the imaging plane 51. For example, at least one of the second incident surface 421, the second reflective surface group 422 (the second reflective surface 422a, the fourth reflective surface 422b, the sixth reflective surface 422c, the eighth reflective surface 422d), and the second exit surface 423 may include a freeform surface.

The first optical system 41D and the second optical system 42D allow the first light beam group L1 and the second light beam group L2 to be incident on the imaging plane 51 in different directions. The first optical system 41D and the second optical system 42D are configured to allow the first formation image and the second formation image to overlap each other within the imaging plane 51. In the present embodiment, the first optical system 41D and the second optical system 42D are set to allow the image point of the first optical system 41D and the image point of the second optical system 42D to coincide with the same position within the imaging plane 51.

The first optical system 41D and the second optical system 42D are constituted by the prism 40D.

The prism 40D includes the first surface 401 and the second surface 402 which face each other in the thickness direction (the ±Z direction). The first surface 401 and the second surface 402 span from one end in the +X direction to the other end in the −X direction, of the prism 40D. In the present embodiment, the prism 40D is located to allow the imaging plane 51 of the imaging element 5 to face the second surface 402.

The first incident surface 411 of the first optical system 41D and the second incident surface 421 of the second optical system 42D are located within the same first surface 401 of the prism 40D. The first incident surface 411 and the second incident surface 421 are regions which do not overlap each other. This configuration can facilitate forming the prism 40D and allow its shape to be bilaterally symmetrical. The first incident surface 411 and the second incident surface 421 are located on opposite sides in the length direction (the ±X direction) in the first surface 401 of the prism 40D.

The first reflective surface 412a of the first optical system 41D and the second reflective surface 422a of the second optical system 42D are located within the same second surface 402 being part of the prism 40D and facing each of the first incident surface 411 and the second incident surface 421. The first reflective surface 412a and the second reflective surface 422a are regions which do not overlap each other. This can facilitate forming the prism 40D and allow its shape to be bilaterally symmetrical. The first reflective surface 412a and the second reflective surface 422a are located on opposite side in the length direction (the ±X direction) in the second surface 402 of the prism 40D.

The third reflective surface 412b of the first optical system 41D and the fourth reflective surface 422b of the second optical system 42D are located within the same first surface 401 being part of the prism 40D and facing each of the first reflective surface 412a and the second reflective surface 422a. The third reflective surface 412b and the fourth reflective surface 422b are regions which do not overlap each other. This can facilitate forming the prism 40D and allow its shape to be bilaterally symmetrical. The third reflective surface 412b and the fourth reflective surface 422b are located at a center in the length direction (the ±X direction) in the second surface 402 of the prism 40D.

The fifth reflective surface 412c of the first optical system 41D and the sixth reflective surface 422c of the second optical system 42D are located within the same first surface 401 being part of the prism 40D and facing each of the first reflective surface 412a and the second reflective surface 422a. The fifth reflective surface 412c and the sixth reflective surface 422c are regions which do not overlap each other. This can facilitate forming the prism 40D and allow its shape to be bilaterally symmetrical. The fifth reflective surface 412c is located within the same first surface 401 as the first incident surface 411 and the third reflective surface 412b are, but is located between the first incident surface 411 and the third reflective surface 412b and thus do not overlap the first incident surface 411 and the third reflective surface 412b. The sixth reflective surface 422c is located within the same first surface 401 as the second incident surface 421 and the fourth reflective surface 422b are, but is located between the second incident surface 421 and the fourth reflective surface 422b and thus do not overlap the second incident surface 421 and the fourth reflective surface 422b.

The seventh reflective surface 412d of the first optical system 41D and the eighth reflective surface 422d of the second optical system 42D are located within the same second surface 402 being part of the prism 40D and facing each of the fifth reflective surface 412c and the sixth reflective surface 422c. The seventh reflective surface 412d and the eighth reflective surface 422d are regions which do not overlap each other. This can facilitate forming the prism 40D and allow its shape to be bilaterally symmetrical. The seventh reflective surface 412d is located within the same second surface 402 as the first reflective surface 412a and the first exit surface 413 are, but is located between the first reflective surface 412a and the first exit surface 413 and thus do not overlap the first reflective surface 412a and the first exit surface 413. The eighth reflective surface 422d is located within the same second surface 402 as the second reflective surface 422a and the second exit surface 423 are, but is located between the second reflective surface 422a and the second exit surface 423 and thus do not overlap the second reflective surface 422a and the second exit surface 423.

The first optical system 41D and the second optical system 42D, which are described above, allow the first light beam group L1 and the second light beam group L2 to be incident on the imaging plane 51 in different directions. Therefore, it is possible to allow the first light beam group L1 and the second light beam group L2 to be incident on the same imaging plane 51, by use of the first optical system 41D and the second optical system 42D.

The first optical system 41D and the second optical system 42D are line-symmetric in a manner similar to the first optical system 41 and the second optical system 42.

In the aforementioned optical system 4D, the first optical system 41D allows the first light beam group L1 to form the first formation image on the imaging plane 51, by use of the first reflective surface group 412 (the first reflective surface 412a, the third reflective surface 412b, the fifth reflective surface 412c, and the seventh reflective surface 412d). The second optical system 42D allows the second light beam group L2 to form the second formation image on the imaging plane 51, by use of the second reflective surface group 422 (the second reflective surface 422a, the fourth reflective surface 422b, the sixth reflective surface 422c, and the eighth reflective surface 422d). Apparently, the optical system 4D does not include any optical element which causes large loss of light beam groups, such as a half mirror, and makes it possible to reduce loss of light beam groups (the first light beam group L1 and the second light beam group L2) allowed to be incident on the imaging plane 51.

### 1.5.2 Advantageous Effects

The aforementioned optical system 4D allows, in relation to the image projection device 1 projecting images on eyes of the observer 10, the first light beam group L1 forming a first image to be projected on the first eye 11 of the observer 10 and the second light beam group L2 forming a second image to be projected on the second eye 12 of the observer 10, to form images on the imaging plane 51. The optical system 4D includes the first optical system 41D for allowing the first light beam group L1 to form the first formation image P1 on the imaging plane 51 and the second optical system 42D for allowing the second light beam group L2 to form the second formation image P2 on the imaging plane 51. The first optical system 41D includes the first reflective surface group 412 which reflects the first light beam group L1 to allow the first light beam group L1 to be incident on the imaging plane 51 and includes at least the first reflective surface 412a with a concave shape. The second optical system 42D includes the second reflective surface group 422 which reflects the second light beam group L2 to allow the second light beam group L2 to be incident on the imaging plane 51 and includes at least the second reflective surface 422a with a concave shape. The first formation image P1 and the second formation image P2 overlap each other within the imaging plane 51. This configuration enables reducing loss of the first light beam group L1 and the second light beam group L2 to be incident on the imaging plane 51.

### 1.6 Embodiment 6

### 1.6.1 Configuration

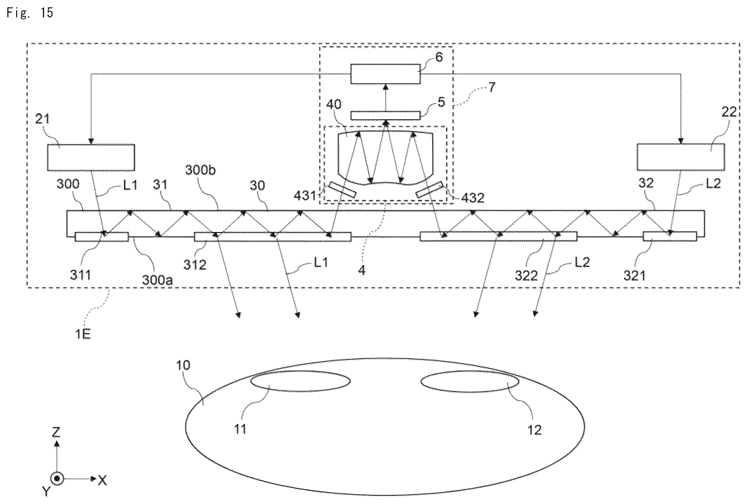

FIG. 15 is a schematic view of a configuration example of an image projection device 1E according to embodiment 6. The image projection device 1E includes the first image unit 21, the second image unit 22, a light guide 30, the optical system 4, the imaging element 5, and the detector 6. In the image projection device 1E, the optical system 4, the imaging element 5, and the detector 6 constitute the display position detection device 7. Note that, the optical system 4 may be replaced with the optical system 4A, 4B, 4C, or 4D.

In the image projection device 1E, the light guide 30 includes the first light guide 31 and the second light guide 32. In the present embodiment, the first light guide 31 and the second light guide 32 are formed integrally as the light guide 30.

The light guide 30 includes a body 300, the first in-coupling region 311, the first reproduction region 312, the second in-coupling region 321, and the second reproduction region 322.

The body 300 is made of a material that is transparent in a visible light region. Therefore, the observer 10 can visually perceive a real world via the body 300. The body 300 have a plate shape. The body 300 includes a first surface 300a and a second surface 300b in a thickness directions of the body 300. The body 300 is positioned to direct the first surface 300a toward the observer 10.

The first in-coupling region 311 and the first reproduction region 312 are formed in or on the first surface 300a of the body 300. The first in-coupling region 311 is located on a first end side (a −X direction side) of the body 300, and the first reproduction region 312 is located on a central part of the body 300. The first in-coupling region 311 and the first reproduction region 312 are constituted by diffraction structures causing diffraction effect for the first light beam group L1. The diffraction structure of the first in-coupling region 311 is a reflection surface-relief diffraction grating, for example. The diffraction structure of the first reproduction region 312 is a transmission surface-relief diffraction grating, for example.

The second in-coupling region 321 and the second reproduction region 322 are formed in or on the first surface 300a of the body 300. The second in-coupling region 321 is located on a second end side (a +X direction side) of the body 300, and the second reproduction region 322 is located on a central part of the body 300. The second in-coupling region 321 and the second reproduction region 322 are constituted by diffraction structures causing diffraction effect for the second light beam group L2. The diffraction structure of the second in-coupling region 321 is a reflection surface-relief diffraction grating, for example. The diffraction structure of the second reproduction region 322 is a transmission surface-relief diffraction grating, for example.

In the light guide 30, the first in-coupling region 311, the first reproduction region 312, and part of the body 300 constitute the first light guide 31. In the light guide 30, the second in-coupling region 321, the second reproduction region 322, and part of the body 300 constitute the second light guide 32.

In the image projection device 1E, the optical system 4 is located to face the second surface 300b of the body 300 of the light guide 30. One or some of a plurality of first light beam groups L1 traveling from the first light guide 31 of the light guide 30 toward the first eye 11 of the observer 10 is incident on the optical system 4. One or some of a plurality of second light beam groups L2 traveling from the second light guide 32 of the light guide 30 toward the second eye 12 of the observer 10 is incident on the optical system 4.

### 1.6.2 Advantageous Effects

In the aforementioned image projection device 1E, the first light guide 31 and the second light guide 32 are formed integrally. This configuration allows handling the first light guide 31 and the second light guide 32 as a single part. Thus, position alignment of the first light guide 31 and the second light guide 32 becomes unnecessary. This makes it easier to locate the first light guide 31 and the second light guide 32. Accordingly, it is possible to facilitate manufacturing the image projection device 1E.

### 1.7 Embodiment 7

### 1.7.1 Configuration

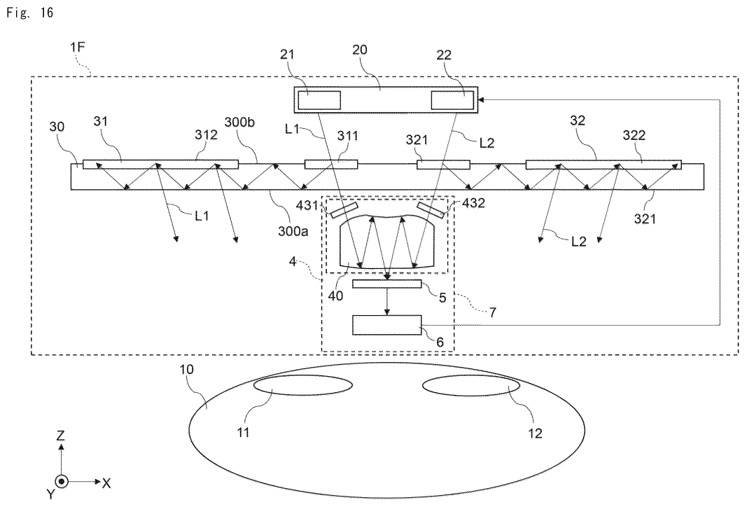

FIG. 16 is a schematic view of a configuration example of an image projection device 1F according to embodiment 7. The image projection device 1F includes an image unit 20, the light guide 30, the optical system 4, the imaging element 5, and the detector 6. In the image projection device 1F, the optical system 4, the imaging element 5, and the detector 6 constitute the display position detection device 7. Note that, the optical system 4 may be replaced with the optical system 4A, 4B, 4C, or 4D.

The image unit 20 includes the first image unit 21 and the second image unit 22. In the present embodiment, the first image unit 21 and the second image unit 22 are formed integrally as the image unit 20.

The light guide 30 includes the body 300, the first in-coupling region 311, the first reproduction region 312, the second in-coupling region 321, and the second reproduction region 322.

In FIG. 16, the first in-coupling region 311 and the first reproduction region 312 are formed in or on the second surface 300b of the body 300. The first in-coupling region 311 is located at the central part of the body 300 and the first reproduction region 312 is located on the first end side (the +X direction side) of the body 300. The first in-coupling region 311 and the first reproduction region 312 are constituted by diffraction structures causing diffraction effect for the first light beam group L1. The diffraction structure of the first in-coupling region 311 is a transmission surface-relief diffraction grating, for example. The diffraction structure of the first reproduction region 312 is a reflection surface-relief diffraction grating, for example.

In FIG. 16, the second in-coupling region 321 and the second reproduction region 322 are formed in or on the second surface 300b of the body 300. The second in-coupling region 321 is located at the central part of the body 300 and the second reproduction region 322 is located on the second end side (the −X direction side) of the body 300. The second in-coupling region 321 and the second reproduction region 322 are constituted by diffraction structures causing diffraction effect for the second light beam group L2. The diffraction structure of the second in-coupling region 321 is a transmission surface-relief diffraction grating, for example. The diffraction structure of the second reproduction region 322 is a reflection surface-relief diffraction grating, for example.

In the light guide 30, the first in-coupling region 311, the first reproduction region 312, and part of the body 300 constitute the first light guide 31. In the light guide 30, the second in-coupling region 321, the second reproduction region 322, and other part of the body 300 constitute the second light guide 32.

In the image projection device 1F, the optical system 4 is located to face the first surface 300a of the body 300 of the light guide 30. One or some of a plurality of first light beam groups L1 traveling from the first light guide 31 of the light guide 30 toward the first eye 11 of the observer 10 is incident on the optical system 4. One or some of a plurality of second light beam groups L2 traveling from the second light guide 32 of the light guide 30 toward the second eye 12 of the observer 10 is incident on the optical system 4.

### 1.7.2 Advantageous Effects

In the aforementioned image projection device 1F, the first image unit 21 and the second image unit 22 are formed integrally. This configuration allows handling the first image unit 21 and the second image unit 22 as a single part. Thus, position alignment of the first image unit 21 and the second image unit 22 becomes unnecessary. This makes it easier to locate the first image unit 21 and the second image unit 22. Accordingly, it is possible to facilitate manufacturing the image projection device 1F. Further, in the aforementioned image projection device 1F, the first light guide 31 and the second light guide 32 are formed integrally. This configuration allows handling the first light guide 31 and the second light guide 32 as a single part. Thus, position alignment of the first light guide 31 and the second light guide 32 becomes unnecessary. This makes it easier to locate the first light guide 31 and the second light guide 32. Accordingly, it is possible to facilitate manufacturing the image projection device 1F.

### 1.8 Embodiment 8

### 1.8.1 Configuration

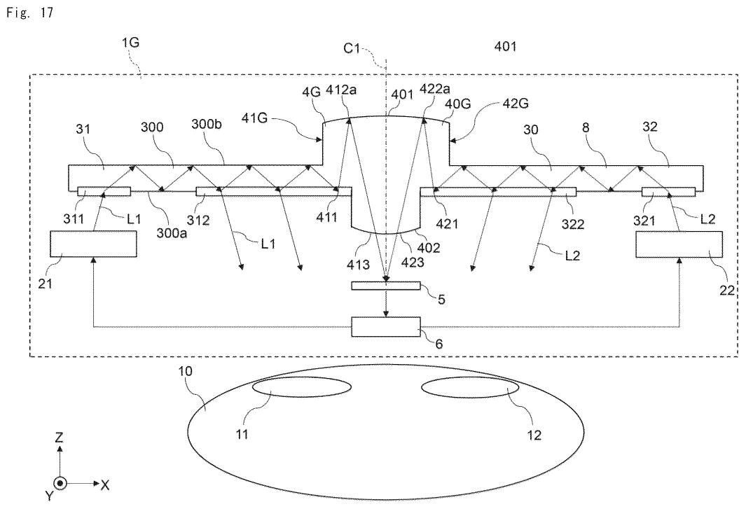

FIG. 17 is a schematic view of a configuration example of an image projection device 1G according to embodiment 8. The image projection device 1G includes the first image unit 21, the second image unit 22, an optical member 8, the imaging element 5, and the detector 6.

In the image projection device 1G, the optical member 8 includes the light guide 30 and an optical system 4G. In the present embodiment, the light guide 30 and the optical system 4G are formed integrally as the optical member 8. This allows handling the first light guide 31, the second light guide 32, and the optical system 4 as a single part. Thus, position alignment of the first light guide 31, the second light guide 32, and the optical system 4 becomes unnecessary. This makes it easier to locate the first light guide 31, the second light guide 32, and the optical system 4.

The optical system 4G includes a first optical system 41G and a second optical system 42G. In the optical system 4G, the first optical system 41G and the second optical system 42G are constituted by a prism 40G.

The first optical system 41G includes the first incident surface 411, the first reflective surface group 412, and the first exit surface 413. The first reflective surface group 412 includes the first reflective surface 412a with a concave shape. The second optical system 42G includes the second incident surface 421, the second reflective surface group 422, and the second exit surface 423. The second reflective surface group 422 includes the second reflective surface 422a with a concave shape.

The first optical system 41G and the second optical system 42G allow the first light beam group L1 and the second light beam group L2 to be incident on the imaging plane 51 in different directions. The first optical system 41G and the second optical system 42G are configured to allow the first formation image and the second formation image to overlap each other within the imaging plane 51. In the present embodiment, the first optical system 41G and the second optical system 42G are set to allow the image point of the first optical system 41 and the image point of the second optical system 42 to coincide with the same position within the imaging plane 51.

As shown in FIG. 17, the first optical system 41G and the second optical system 42G are constituted by the prism 40G.

The prism 40G is formed integrally with the body 300 of the light guide 30. The prism 40G includes the first surface 401 and the second surface 402 which protrudes from the central part of the body 300 in both directions in which the first surface 300a and the second surface 300b of the body 300 face, and face each other in the thickness direction (the ±Z direction). The prism 40G is located to allow the second surface 402 to face the imaging plane 51 of the imaging element 5.

The first incident surface 411 of the first optical system 41G is defined by an interface between a part functioning as the prism 40G and a part functioning as the first light guide 31 of the light guide 30 within the optical member 8. In the optical member 8, one or more of a plurality of first light beam groups L1 traveling from the first light guide 31 toward the first eye 11 of the observer 10 is incident on the optical system 4G. The first reproduction region 312 of the first light guide 31 includes a part reflecting the first light beam group L1 toward the first reflective surface 412a, and this part defines the first incident surface 411.

The second incident surface 421 of the second optical system 42G is defined by an interface between a part functioning as the prism 40G and a part functioning as the second light guide 32 of the light guide 30 within the optical member 8. In the optical member 8, one or more of a plurality of second light beam groups L2 traveling from the second light guide 32 toward the second eye 12 of the observer 10 is incident on the optical system 4G. The second reproduction region 322 of the second light guide 32 includes a part reflecting the second light beam group L2 toward the second reflective surface 422a, and this part defines the second incident surface 421.

The first reflective surface 412a of the first optical system 41G and the second reflective surface 422a of the second optical system 42G are located within the same first surface 401 being part of the prism 40G and facing each of the first incident surface 411 and the second incident surface 421. The first reflective surface 412a and the second reflective surface 422a are regions which do not overlap each other. This can facilitate forming the prism 40G and allow its shape to be bilaterally symmetrical. The first reflective surface 412a and the second reflective surface 422a are located on opposite sides in the length direction (the ±X direction) in the first surface 401 of the prism 40G.

The first exit surface 413 of the first optical system 41G and the second exit surface 423 of the second optical system 42G are located within the same second surface 402 being part of the prism 40G and facing each of the first reflective surface 412a and the second reflective surface 422a. The first exit surface 413 and the second exit surface 423 are regions which partially overlap each other. This allows decreasing a region of the prism 40G necessary for providing the first exit surface 413 and the second exit surface 423. The first exit surface 413 and the second exit surface 423 are located at the center in the length direction (the #X direction) in the second surface 402 of the prism 40G.

The first optical system 41G and the second optical system 42G, which are described above, allow the first light beam group L1 and the second light beam group L2 to be incident on the imaging plane 51 in different directions. Therefore, it is possible to allow the first light beam group L1 and the second light beam group L2 to be incident on the same imaging plane 51, by use of the first optical system 41G and the second optical system 42G.

The first optical system 41G and the second optical system 42G are line-symmetric in a manner similar to the first optical system 41 and the second optical system 42.

In the aforementioned optical system 4G, the first optical system 41G allows the first light beam group L1 to form the first formation image on the imaging plane 51, by use of the first reflective surface group 412 (the first reflective surface 412a). The second optical system 42G allows the second light beam group L2 to form the second formation image on the imaging plane 51, by use of the second reflective surface group 422 (the second reflective surface 422a). Apparently, the optical system 4G does not include any optical element which causes large loss of light beam groups, such as a half mirror, and makes it possible to reduce loss of light beam groups (the first light beam group L1 and the second light beam group L2) allowed to be incident on the imaging plane 51.

### 1.8.2 Advantageous Effects

The aforementioned optical system 4G includes the first light guide 31 allowing propagation of the first light beam group L1 toward the first eye 11 of the observer 10 and the second light guide 32 allowing propagation of the second light beam group L2 toward the second eye 12 of the observer 10. The prism 40G constituting the first optical system 41G and the second optical system 42G is formed integrally with the first light guide 31 and the second light guide 32 to allow part of the first light beam group L1 propagating inside the first light guide 31 to be incident on the first incident surface 411 as well as to allow part of the second light beam group L2 propagating inside the second light guide 32 to be incident on the second incident surface 421. This configuration makes it unnecessary to couple the prism 40G with the first light guide 31 and the second light guide 32. This configuration makes it possible to downsize a structure in which the prism 40G is included in the first light guide 31 and the second light guide 32.

### 2. Variations

Embodiments of the present disclosure are not limited to the above embodiments. The above embodiments may be modified in various ways in accordance with designs or the like to an extent that they can achieve the problem of the present disclosure. Hereinafter, some variations or modifications of the above embodiments will be listed. One or more of the variations or modifications described below may apply in combination with one or more of the others.

Note that, hereinafter, if variations can be applied to any of the above embodiments 1 to 8, explanation thereof will be made with reference to reference signs used in embodiment 1. This is just for simplifying the specification or description, and there is no intent to withdraw application to embodiments 2 to 8.

In embodiment 1, the first formation image P1 and the second formation image P2 overlap each other within the imaging plane 51. The reference positions R1 and R2 are the same positions (e.g., central positions) in the first and second formation images P1 and P2.

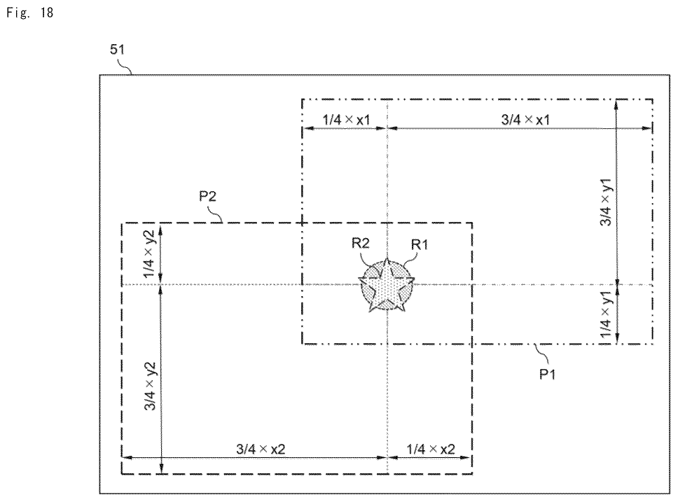

In one variation, within the imaging plane 51, the first formation image P1 and the second formation image P2 may overlap each other not completely but partially. The reference positions R1 and R2 may be different positions in the first and second formation images P1 and P2. FIG. 18 is an explanatory diagram of examples of the first formation image P1 and the second formation image P2 according to one example. In FIG. 18, the first formation image P1 has a width x1 and a height y1 and the second formation image P2 has a width x2 and a height y2. A lower left quadrant of the first formation image P1 and an upper right quadrant of the second formation image P2 overlap each other. In other words, a size of an overlap between the first formation image P1 and the second formation image P2 within the imaging plane 51 is 25% of a size of the first formation image P1 or the second formation image P2. The reference position R1 is a position offset from a lower left corner of the first formation image P1 by one quarter of the width x1 and one quarter of the height y1. The reference position neR2 is a position offset from an upper right corner of the second formation image P2 by one quarter of the width x2 and one quarter of the height y2. When the reference position R1 of the first formation image P1 and the reference position R2 of the second formation image P2 overlap each other within the imaging plane 51, it is possible to determine that the display positions of the first formation image P1 and the second formation image P2 are correct positions. When the first formation image P1 and the second formation image P2 overlap with an overlap therebetween being equal to or larger than 20% of their sizes, it is possible to display an overlap between the two reference positions R1 and R2 within the imaging plane 51. This makes it possible to easily determine that the display positions of the first formation image P1 and the second formation image P2 are correct positions.

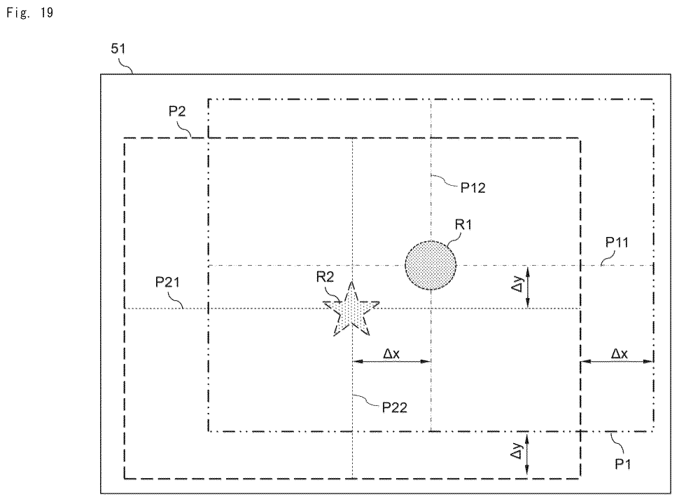

In another variation, within the imaging plane 51, the first formation image P1 and the second formation image P2 may overlap each other not completely but partially. The reference positions R1 and R2 may not be set to overlap each other even if the display positions of the first and second formation images P1 and P2 are correct. FIG. 19 is an explanatory diagram of examples of the first formation image P1 and the second formation image P2 according to the other variation. With regard to the first formation image P1, width and height reference lines P11 and P12 are drawn to indicate a width position and a height position of a correct reference position. When the reference position R1 is located at an intersection point of the reference lines P11 and P12, it is possible to determine that the display position of the first formation image P1 is a correct position. With regard to the second formation image P2, width and height reference lines P21 and P22 are drawn to indicate a width position and a height position of a correct reference position. When the reference position R2 is located at an intersection point of the reference lines P21 and P22, it is possible to determine that the display position of the second formation image P2 is a correct position. Alternatively, the display position detection device 7 may memorize that the first formation image P1 and the second formation image P2 are displaced by Δx in width, and Δy in height. Detecting that a width displacement and a height displacement between the reference position R1 of the first formation image P1 and the reference position R2 of the second formation image P2 are Δx and Δy makes it possible to determine that the display positions of the first formation image P1 and the second formation image P2 are correct positions.

In one variation, configurations of the first image unit 21 and the second image unit 22 are not limited particularly. The first image unit 21 and the second image unit 22 may be separate or discrete devices or may be a single device. When the first image unit 21 and the second image unit 22 are a single device, the first light beam group L1 and the second light beam group L2 may be output alternatively in time or may be output simultaneously by using polarization or the like.

In one variation, configurations of the first light guide 31 and the second light guide 32 are not limited particularly. The first light guide 31 and the second light guide 32 may not always have pupil expansion functionality.

In one variation, the optical system 4 may include at least the first optical system 41 and the second optical system 42. In other words, the first aperture stop 431, the second aperture stop 432, the first converging optical system 451, and the second converging optical system 452 are optional.

In one variation, the first reflective surface group 412 of the first optical system 41 may include at least the first reflective surface 412a. In other words, the first reflective surface group 412 of the first optical system 41 may be constituted by only a single reflective surface. However, the first reflective surface group 412 may include two or more reflective surfaces, and this may relax restriction for arrangement of the first image unit 21 and the imaging plane 51.

In one variation, the second reflective surface group 422 of the second optical system 42 may include at least the second reflective surface 422a. In other words, the second reflective surface group 422 of the second optical system 42 may be constituted by only a single reflective surface. However, the second reflective surface group 422 may include two or more reflective surfaces, and this may relax restriction for arrangement of the second image unit 22 and the imaging plane 51.

In one variation, at least one of the first incident surface 411, the first reflective surface group 412, the first exit surface 413, the second incident surface 421, the second reflective surface group 422, or the second exit surface 423 may include a freeform surface. This configuration can improve the degree of freedom of design of the prism 40.

In one variation, the detection process by the detector 6 may be performed real-time. In other words, the detector 6 may detect the positional relation between the first formation image and the second formation image even while the first light beam group L1 and the second light beam L2 are output from the first image unit 21 and the second image unit 22, respectively so that the observer 10 watches a 3D image. This enables real-time correction of positional displacement of the first formation image and the second formation image.

### 3. Aspects

As apparent from the above embodiments and variations, the present disclosure includes the following aspects. Hereinafter, reference signs in parenthesis are attached for the purpose of clearly showing correspondence with the embodiments only. Note that, in consideration of readability of texts, the reference signs in parentheses may be omitted from the second and subsequent times.

A first aspect is an optical system (4; 4A; 4B; 4D; 4G) for allowing, in relation to an image projection device (1) projecting images on eyes of an observer (10), a first light beam group (L1) forming a first image to be projected on a first eye (11) of the observer (10) and a second light beam group (L2) forming a second image to be projected on a second eye (12) of the observer (10), to form images on an imaging plane (51), includes: a first optical system (41; 41A; 41B; 41D; 41G) for allowing the first light beam group (L1) to form a first formation image (P1) on the imaging plane (51); and a second optical system (42; 42A; 42B; 42D; 42G) for allowing the second light beam group (L2) to form a second formation image (P2) on the imaging plane (51). The first optical system (41; 41A; 41B; 41D; 41G) includes a first reflective surface group (412) which reflects the first light beam group (L1) to allow the first light beam group (L1) to be incident on the imaging plane (51) and includes at least a first reflective surface (412a) with a concave shape. The second optical system (42; 42A; 42B; 42D; 42G) includes a second reflective surface group (422) which reflects the second light beam group (L2) to allow the second light beam group (L2) to be incident on the imaging plane (51) and includes at least a second reflective surface (422a) with a concave shape. The first formation image (P1) and the second formation image (P2) overlap each other within the imaging plane (51). This aspect enables reducing loss of light beam groups (the first light beam group L1 and the second light beam group L2) to be incident on the imaging plane (51).

A second aspect is the optical system (4; 4A; 4B; 4D; 4G) based on the first aspect. In this aspect, the first optical system (41; 41A; 41B; 41D; 41G) and the second optical system (42; 42A; 42B; 42D; 42G) allow the first light beam group (L1) and the second light beam group (L2) to be incident on the imaging plane (51) in different directions. This aspect makes it possible to allow the first light beam group (L1) and the second light beam group (L2) to be incident on the same imaging plane (51), by use of the first optical system (41; 41A; 41B; 41D; 41G) and the second optical system (42; 42A; 42B; 42D; 42G).

A third aspect is the optical system (4; 4A; 4B; 4D; 4G) based on the second aspect. In this aspect, within a plane passing through a perpendicular line (V1) of the imaging plane (51), the first optical system (41; 41A; 41B; 41D; 41G) and the second optical system (42; 42A; 42B; 42D; 42G) are line-symmetric with regard to the perpendicular line (V1) of the imaging plane (51). This aspect allows application to configuration where light beam groups are incident in left and right directions.

A fourth aspect is the optical system (4; 4A; 4B; 4D; 4G) based on any one of the first to third aspects. In this aspect, within the first reflective surface group (412), the first reflective surface (412a) is located farthest from the imaging plane (51) along an optical path of the first light beam group (L1). Within the second reflective surface group (422), the second reflective surface (422a) is located farthest from the imaging plane (51) along an optical path of the second light beam group (L2). This configuration allows the first light beam group (L1) and the second light beam group (L2) to be directed (converge) from the magnifying side toward the reducing side and thereby from images on the imaging plane (51).

A fifth aspect is the optical system (4; 4B; 4D; 4G) based on the fourth aspect. In this aspect, the first reflective surface group (412) includes a third reflective surface (412b) with a convex shape which reflects the first light beam group (L1) which has been reflected by the first reflective surface (412a); and the second reflective surface group (422) includes a fourth reflective surface (422b) with a convex shape which reflects the second light beam group (L2) which has been reflected by the second reflective surface (422a). This aspect allows the first light beam group (L1) and the second light beam group (L2) to be directed (converge) from the magnifying side toward the reducing side and thereby from images on the imaging plane (51).

A sixth aspect is the optical system (4; 4A; 4D; 4G) based on any one of the first to fifth aspects. In this aspect, the first optical system (41; 41A; 41D; 41G) and the second optical system (42; 42A; 42D; 42G) are constituted by a prism (40; 40A; 40D; 40G). The first optical system (41; 41A; 41D; 41G) further includes a first incident surface (411) allowing the first light beam group (L1) to enter the prism (40; 40A; 40D; 40G) and a first exit surface (413) allowing the first light beam group (L1) to emerge from the prism (40; 40A; 40D; 40G) to the imaging plane (51). The first reflective surface group (412) reflects the first light beam group (L1) inside the prism (40; 40A; 40D; 40G). The second optical system (42; 42A; 42D; 42G) further includes a second incident surface (421) allowing the second light beam group (L2) to enter the prism (40) and a second exit surface (423) allowing the second light beam group (L2) to emerge from the prism (40; 40A; 40D; 40G) to the imaging plane (51). The second reflective surface group (422) reflects the second light beam group (L2) inside the prism (40; 40A; 40D; 40G). This aspect enables integrated molding of the first optical system (41; 41A; 41D; 41G) and the second optical system (42; 42A; 42D; 42G) as well as downsizing them.

A seventh aspect is the optical system (4; 4A; 4D) based on the sixth aspect. This aspect further includes a first aperture stop (431) located outside the prism (40; 40A; 40D) to face the first incident surface (411); and a second aperture stop (432) located outside the prism (40; 40A; 40D) to face the second incident surface (421). This aspect can reduce the likelihood of unnecessary light entering the first optical system (41; 41A; 41D) and the second optical system (42; 42A; 42D).

An eighth aspect is the optical system (4; 4A; 4D; 4G) based on the sixth or seventh aspect. In this aspect, the first exit surface (413) and the second exit surface (423) are located within a transmissive surface which is part of the prism (40; 40A; 40D; 40G) and faces the imaging plane (51), and are regions which partially overlap each other. This aspect allows decreasing a region of the prism (40; 40A; 40D; 40G) necessary for providing the first exit surface (413) and the second exit surface (423).

A ninth aspect is the optical system (4; 4D; 4G) based on any one of the sixth to eighth aspects. In this aspect, the first reflective surface group (412) includes a third reflective surface (412b) with a convex shape which reflects the first light beam group (L1) which has been reflected by the first reflective surface (412a). The second reflective surface group (422) includes a fourth reflective surface (422b) with a convex shape which reflects the second light beam group (L2) which has been reflected by the second reflective surface (422a). The third reflective surface (412b) and the fourth reflective surface (422b) are located within the same first surface (401) being part of the prism (40; 40A; 40D; 40G) and facing the first exit surface (413) and the second exit surface (423), and are regions which do not overlap each other. This aspect can facilitate forming the prism (40; 40A; 40D; 40G) and allow its shape to be bilaterally symmetrical.

A tenth aspect is the optical system (4; 4A; 4D; 4G) based on any one of the sixth to ninth aspects. In this aspect, the first reflective surface (412a) and the second reflective surface (412b) are located within a same surface (402) being part of the prism and facing each of the first incident surface (411) and the second incident surface (421), and are regions which do not overlap each other. This aspect can facilitate forming the prism (40; 40A; 40D; 40G) and allow its shape to be bilaterally symmetrical.

An eleventh aspect is the optical system (4; 4A; 4D; 4G) based on any one of the sixth to tenth aspects. In this aspect, at least one of the first incident surface (411), the first reflective surface group (412), the first exit surface (413), the second incident surface (421), the second reflective surface group (422), or the second exit surface (423) includes a freeform surface. This aspect enables improvement of the degree of freedom of the design of the prism (40; 40A; 40D; 40G).

A twelfth aspect is the optical system (4G) based on any one of the sixth to eleventh aspects. In this aspect, the optical system (4G) includes a first light guide (31) allowing propagation of the first light beam group (L1) toward the first eye (11) of the observer (10) and a second light guide (32) allowing propagation of the second light beam group (L2) toward the second eye (12) of the observer (10). The prism (40G) constituting the first optical system (41G) and the second optical system (42G) is formed integrally with the first light guide (31) and the second light guide (32) to allow part of the first light beam group (L1) propagating inside the first light guide (31) to be incident on the first incident surface (411) as well as to allow part of the second light beam group (L2) propagating inside the second light guide (32) to be incident on the second incident surface (421). This aspect makes it unnecessary to couple the prism (40G) with the first light guide (31) and the second light guide (32).

A thirteenth aspect is an image projection device (1G) and includes: the optical system (4G) based on the twelfth aspect; a first image unit (21) configured to output the first light beam group (L1); and a second image unit (22) configured to output the second light beam group (L2). This aspect enables reducing loss of light beam groups (the first light beam group L1 and the second light beam group L2) to be incident on the imaging plane (51).

A fourteenth aspect is the optical system (4; 4A; 4B; 4D; 4G) based on any one of the first to twelfth aspects. In this aspect, a size of an overlap between the first formation image (P1) and the second formation image (P2) within the imaging plane (51) is equal to or larger than 20% of the size of the first formation image (P1) or the second formation image (P2). This aspect enables confirming an overlap between the image point of the first optical system (41; 41A; 41B; 41D; 41G) and the image point of the second optical system (42; 42A; 42B; 42D; 42G) by images.

A fifteenth aspect is a display position detection device (7) and includes: the optical system (4; 4A; 4B; 4D; 4G) based on the fourteenth aspect; and the detector (6) configured to detect a positional relation between the first formation image (P1) and the second formation image (P2), from a positional relation between an image point of the first optical system (41) and an image point of the second optical system (42) based on the first formation image (P1) and the second formation image (P2) obtained from the imaging plane (51). This aspect enables confirming position accuracy of the first formation image (P1) and the second formation image (P2).

A sixteenth aspect is an image projection device (1; 1E; 1F; 1G) includes: the optical system (4; 4A; 4B; 4C; 4D; 4G) based on any one of the first to twelfth and fourteenth aspects; a first image unit (21) configured to output the first light beam group (L1); a second image unit (22) configured to output the second light beam group (L2). This aspect enables reducing loss of light beam groups (the first light beam group L1 and the second light beam group L2) to be incident on the imaging plane (51).

A seventeenth aspect is a display position detection device (7) and includes: the optical system (4; 4A; 4B; 4D; 4G); and the detector (6) configured to detect a positional relation between the first formation image (P1) and the second formation image (P2), from a positional relation between an image point of the first optical system (41; 41A; 41B; 41D; 41G) and the image point of the second optical system (42; 42A; 42B; 42D; 42G) based on the first formation image (P1) and the second formation image (P2) obtained from the imaging plane (51). This aspect enables confirming position accuracy of the first formation image (P1) and the second formation image (P2).

The second to twelfth and fourteenth aspects are optional and are not necessary.

### INDUSTRIAL APPLICABILITY

The present disclosure is applicable to optical systems, image projection devices, and display position detection devices. In more detail, the present disclosure is applicable to an optical system for allowing a first light beam group forming a first image to be projected on a first eye of an observer and a second light beam group forming a second image to be projected on a second eye of the observer, to form images on an imaging plane, an image projection device including the optical system, and a display position detection device including the optical system.

### REFERENCE SIGNS LIST

1, 1E, 1F, 1G Image Projection Device
21 First Image Unit
22 Second Image Unit
31 First Light Guide
32 Second Light Guide
4, 4A, 4B, 4C, 4D, 4G Optical System
40, 40A, 40D, 40G Prism
41, 41A, 41B, 41D, 41G First Optical System
411 First Incident Surface
412 First Reflective Surface Group
412a First Reflective Surface
412b Third Reflective Surface
412c Fifth Reflective Surface
412d Seventh Reflective Surface
413 First Exit Surface
42, 42A, 42B, 42D, 42G Second Optical System
421 Second Incident Surface
422 Second Reflective Surface Group
422a Second Reflective Surface
422b Fourth Reflective Surface
422c Sixth Reflective Surface
422d Eighth Reflective Surface
423 Second Exit Surface
431 First Aperture Stop
432 Second Aperture Stop
5 Imaging Element
51 Imaging Plane
6 Detector
7 Display Position Detection Device
L1 First Light Beam Group
L10 First Reference Light Beam
L2 Second Light Beam Group
L20 Second Reference Light Beam
P1 First Formation Image
P2 Second Formation Image
R1 Reference Position (Reference Position of First Formation Image)
R2 Reference Position (Reference Position of Second Formation Image)
O1 Center (Center of Imaging Plane)
T1 First Point
T2 Second Point

1. An optical system for allowing, in relation to an image projection device projecting images on eyes of an observer, a first light beam group forming a first image to be projected on a first eye of the observer and a second light beam group forming a second image to be projected on a second eye of the observer, to form images on an imaging plane, comprising:
a first optical system for allowing the first light beam group to form a first formation image on the imaging plane; and
a second optical system for allowing the second light beam group to form a second formation image on the imaging plane,
the first optical system including a first reflective surface group which reflects the first light beam group to allow the first light beam group to be incident on the imaging plane and includes at least a first reflective surface with a concave shape,
the second optical system including a second reflective surface group which reflects the second light beam group to allow the second light beam group to be incident on the imaging plane and includes at least a second reflective surface with a concave shape, and
the first formation image and the second formation image overlapping each other within the imaging plane.

2. The optical system according to claim 1, wherein the first optical system and the second optical system allow the first light beam group and the second light beam group to be incident on the imaging plane in different directions.

3. The optical system according to claim 2, wherein within a plane passing through a perpendicular line of the imaging plane, the first optical system and the second optical system are line-symmetric with regard to the perpendicular line of the imaging plane.

4. The optical system according to claim 1, wherein:
within the first reflective surface group, the first reflective surface is located farthest from the imaging plane along an optical path of the first light beam group; and
within the second reflective surface group, the second reflective surface is located farthest from the imaging plane along an optical path of the second light beam group.

5. The optical system according to claim 4, wherein:
the first reflective surface group includes a third reflective surface with a convex shape which reflects the first light beam group which has been reflected by the first reflective surface; and
the second reflective surface group includes a fourth reflective surface with a convex shape which reflects the second light beam group which has been reflected by the second reflective surface.

6. The optical system according to claim 1, wherein:
the first optical system and the second optical system are constituted by a prism;
the first optical system further includes a first incident surface allowing the first light beam group to enter the prism and a first exit surface allowing the first light beam group to emerge from the prism to the imaging plane;
the first reflective surface group reflects the first light beam group inside the prism;
the second optical system further includes a second incident surface allowing the second light beam group to enter the prism and a second exit surface allowing the second light beam group to emerge from the prism to the imaging plane; and
the second reflective surface group reflects the second light beam group inside the prism.

7. The optical system according to claim 6, further comprising:
a first aperture stop located outside the prism to face the first incident surface; and
a second aperture stop located outside the prism to face the second incident surface.

8. The optical system according to claim 6, wherein the first exit surface and the second exit surface are located within a transmissive surface which is part of the prism and faces the imaging plane, and are regions which partially overlap each other.

9. The optical system according to claim 6, wherein
the first reflective surface group includes a third reflective surface with a convex shape which reflects the first light beam group which has been reflected by the first reflective surface;
the second reflective surface group includes a fourth reflective surface with a convex shape which reflects the second light beam group which has been reflected by the second reflective surface; and
the third reflective surface and the fourth reflective surface are located within a same surface being part of the prism and facing the first exit surface and the second exit surface, and are regions which do not overlap each other.

10. The optical system according to claim 6, wherein the first reflective surface and the second reflective surface are located within a same surface being part of the prism and facing each of the first incident surface and the second incident surface, and are regions which do not overlap each other.

11. The optical system according to claim 6, wherein at least one of the first incident surface, the first reflective surface group, the first exit surface, the second incident surface, the second reflective surface group, or the second exit surface includes a freeform surface.

12. The optical system according to claim 6, comprising:
a first light guide allowing propagation of the first light beam group toward the first eye of the observer; and
a second light guide allowing propagation of the second light beam group toward the second eye of the observer,
wherein the prism constituting the first optical system and the second optical system is formed integrally with the first light guide and the second light guide to allow part of the first light beam group propagating inside the first light guide to be incident on the first incident surface as well as to allow part of the second light beam group propagating inside the second light guide to be incident on the second incident surface.

13. An image projection device comprising:
the optical system according to claim 12;
a first image unit configured to output the first light beam group toward the first light guide; and
a second image unit configured to output the second light beam group toward the second light guide.

14. The optical system according to claim 1, wherein a size of a region of an overlap between the first formation image and the second formation image within the imaging plane is equal to or larger than 20% of a size of the first formation image or the second formation image.

15. A display position detection device comprising:
the optical system according to claim 14; and
a detector configured to detect a positional relation between the first formation image and the second formation image, from a positional relation between an image point of the first optical system and an image point of the second optical system based on the first formation image and the second formation image obtained from the imaging plane.
